(19) United States
(12) Patent Application Publication
(10) Pub. No.: US 2006/0201938 A1
(43) Pub. Date: Sep. 14, 2006

(54) Food serving arrangement

(75) Inventors: John A. Wojcik, Sheboygan, WI (US); David M. Wasserman, Whitefish Bay, WI (US); Daniel R. Nett, Sun Prairie, WI (US); Craig P. Conner, Madison, WI (US); David E. Barnard, St. Paul, MN (US); Julie M. Norvaisas, Madison, WI (US)

Correspondence Address: FOLEY & LARDNER LLP, 777 EAST WISCONSIN AVENUE, MILWAUKEE, WI, 53202-5306, US

(73) Assignee: The Vollrath Company, L.L.C.

(21) Appl. No.: 11/356,718

(22) Filed: Feb. 17, 2006

Related U.S. Application Data
(60) Provisional application No. 60/654,488, filed on Feb. 18, 2005.
(60) Provisional application No. 60/719,428, filed on Sep. 22, 2005.

(51) Int. Cl. H05B 6/72

(52) U.S. Cl. 219/761

(57) ABSTRACT

Various embodiments of a food serving arrangement and its components are disclosed.

### CROSS-REFERENCE TO RELATED APPLICATIONS

The present application claims priority under 35 U.S.C. § 119 from co-pending U.S. Patent Application Ser. No. 60/654,488 filed on Feb. 18, 2005 by Wojcik et al. (Atty. Dkt. No. 062103-0536) and U.S. Patent Application Ser. No. 60/719,428 filed on Sep. 22, 2005 by Wojcik et al. (Atty. Dkt. No. 062103-0574), both entitled FOOD SERVING ARRANGEMENT, wherein the full disclosures of each are hereby incorporated herein by reference.

### BACKGROUND

The present invention relates to a food serving arrangement configured to provide one or more receptacles for containing food.

It is generally known to provide for a food serving arrangements for use in buffets, food service lines, cafeterias, restaurants, and the like. However, such known food serving arrangements has several disadvantages including having limited arrangement possibilies, not being reconfigurable, and the like.

Accordingly, it would be advantageous to provide a compact, sturdy and an aesthetically pleasing arrangement for serving food. It would also be advantageous to provide a food serving arrangement configured to be placed upon a counter, table, shelf or other surface elevated above the ground or a floor. It would also be advantageous to provide a food serving arrangement further be configured to maintain such food at an elevated temperature above room temperature or at a temperature below room temperature. It would also be advantageous to provide a food serving arrangement that is modular and may be configured, reconfigured, arranged, rearranged, and the like to provide any of a variety of arrangements or patterns depending on the desired situation or space available. It would be desirable to provide for a food serving arrangement having one or more of these or other advantageous features. To provide an inexpensive, reliable, and widely adaptable food serving arrangement that avoids the above-referenced and other problems would represent a significant advance in the art.

### SUMMARY

The present invention relates to a food serving arrangement comprising a first pan; a second pan; and a plurality of legs supporting the first pan and the second pan. The first pan and the second pan share a first leg of the plurality of legs between the first pan and the second pan.

The present invention also relates to a food serving arrangement comprising a plurality of food serving units. Each unit having a bottom and a pan spaced from the bottom by less than or equal to about 2 feet. The plurality of units are releasably connected to one another.

The present invention further relates to a food serving arrangement comprising a first food serving unit having a first pan with a first top at a first height; and a second food serving unit connected to the first unit having a second pan with a second top at a second height.

The present invention further relates to a food serving arrangement comprising a plurality of food serving unit. Each unit including a pan. The plurality of food serving units are connected to one another and have a continuous planer, convex, or concave outer perimeter.

The present invention further relates to a food serving unit comprising a first pan; a first housing supporting the first pan; and legs coupled to the housing. The legs include a first leg configured to be releasably connected to a second unit without fasteners.

The present invention further relates to a pan support comprising a first housing configured to support a pan; and legs coupled to the housing. The legs include a first leg configured to be releasably connected to a second housing without fasteners.

The present invention further relates to a method for providing a food serving arrangement. The method comprises providing a food serving unit having at least one pan supported by a leg; and releasably connecting a second food serving unit having a second pan to the leg of the first unit.

The present invention further relates to an apparatus comprising a housing comprising a frame having an opening configured to receive a pan; and a plurality of panels extending non-parallel from the frame. Consecutive panels have spaced edges along corners of the housing.

The present invention further relates to various features and combinations of features shown and described in the disclosed embodiments.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is a perspective view of one example of a food serving arrangement;

FIG. 2 is an exploded view of a food serving unit of the arrangement of FIG. 1;

FIG. 3 is a top plan view of a sheet of metal for a housing of the food serving unit of FIG. 2;

FIG. 4 is a cross-sectional view of a leg of the food serving unit of FIG. 2;

FIG. 5 is a fragmentary sectional view of the unit of FIG. 2;

FIG. 6 is a fragmentary perspective view of an upper portion of the unit of FIG. 2;

FIG. 7 is a fragmentary top perspective view of a lower portion of the unit of FIG. 2;

FIG. 8A is a perspective view of a first unit;

FIG. 8B is a sectional view of the housing unit of FIG. 8A;

FIG. 9A is a perspective view of a second unit;

FIG. 9B is a sectional view of the unit of FIG. 9A;

FIG. 10A is a perspective view of a third unit;

FIG. 10B is a sectional view of the unit of FIG. 10A;

FIG. 11 is a perspective view of a food serving unit with utensil management and signage according to an exemplary embodiment;

FIG. 12 is a perspective view of a food serving unit with a cover shown as a breathguard according to an exemplary embodiment;

FIG. 13 is a perspective view of a food serving unit with lighting and signage according to an exemplary embodiment;

FIG. 14 is a perspective view of a first set of pans for use in a food serving arrangement;

FIG. 15 is a perspective view of a second set of pans for use in a food servicing arrangement;

FIG. 16 is a perspective view of an alternative embodiment of the food serving arrangement of FIG. 1;

FIG. 17 is a perspective view of an alternative embodiment of the food serving arrangement of FIG. 1;

FIG. 18 is a perspective view of an alternative embodiment of the food serving arrangement of FIG. 1;

FIG. 19 is a perspective view of an alternative embodiment of the food serving arrangement of FIG. 1;

FIG. 20 is a perspective view of an alternative embodiment of the food serving arrangement of FIG. 1;

FIG. 21 is a perspective view of an alternative embodiment of the food serving arrangement of FIG. 1;

FIG. 22 is a perspective view of an alternative embodiment of the food serving arrangement of FIG. 1 and includes integrated condiments and accouterments;

FIG. 23 is a perspective view of an alternative embodiment of the food serving arrangement of FIG. 1;

FIG. 24 is a perspective view of an alternative embodiment of the food serving arrangement of FIG. 1;

FIG. 25 is a perspective view of an alternative embodiment of the food serving arrangement of FIG. 1;

FIG. 26 is a perspective view of an alternative embodiment of the food serving arrangement of FIG. 1 configured to, for example, bend around corners;

FIG. 27 is a perspective view of an alternative embodiment of the food serving arrangement of FIG. 1 configured to, for example, provide a two-sided buffet;

FIG. 28 is a perspective view of an alternative embodiment of the food serving arrangement of FIG. 1 configured for use to provide condiments and accouterments;

FIG. 29 is a perspective view of an alternative embodiment of the food serving arrangement of FIG. 1 configured for use to provide condiments and accouterments;

FIG. 30 is a series of top views of alternative embodiments of food serving arrangements;

FIG. 31 is a fragmentary exploded perspective view of a food serving arrangement;

FIG. 32 is a perspective view of a leg according to an exemplary embodiment;

FIG. 33 is a fragmentary section view of the food serving arrangement of FIG. 31; and

FIG. 34 is a perspective view of a leg according to an alternative embodiment.

### DETAILED DESCRIPTION OF THE PREFERRED EMBODIMENTS

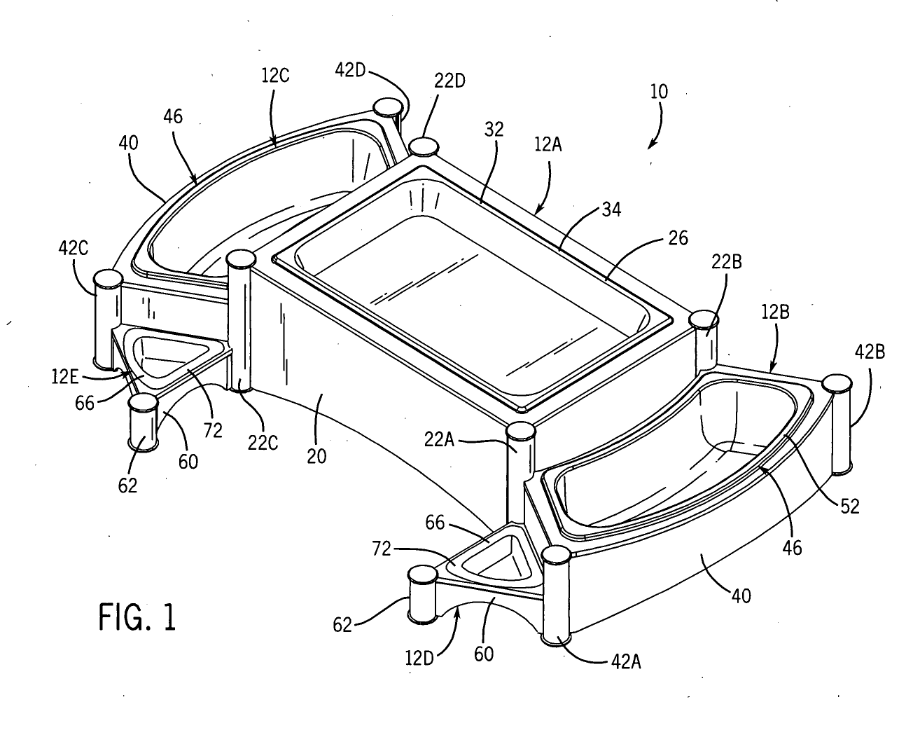

FIG. 1 is a top perspective view of one example of a food serving arrangement 10. In exemplary embodiments, food serving arrangement 10 is modular and may be configured, reconfigured, arranged, rearranged, and the like to provide any of a variety of arrangements or patters depending on the desired situation or space available. Food serving arrangement 10 is configured to be placed upon a counter, table, shelf or other surface elevated above the ground or a floor. Food serving arrangement 10 is configured to provide one or more receptacles for containing food. In particular embodiments, food servicing arrangement 10 may further be configured to maintain such food at an elevated temperature above room temperature or at a temperature below room temperature. Food serving arrangement 10 provides a compact, sturdy and an aesthetically pleasing arrangement for serving food. Food serving arrangement 10 is well suited for use in buffets, food service lines, cafeterias, restaurants, and the like.

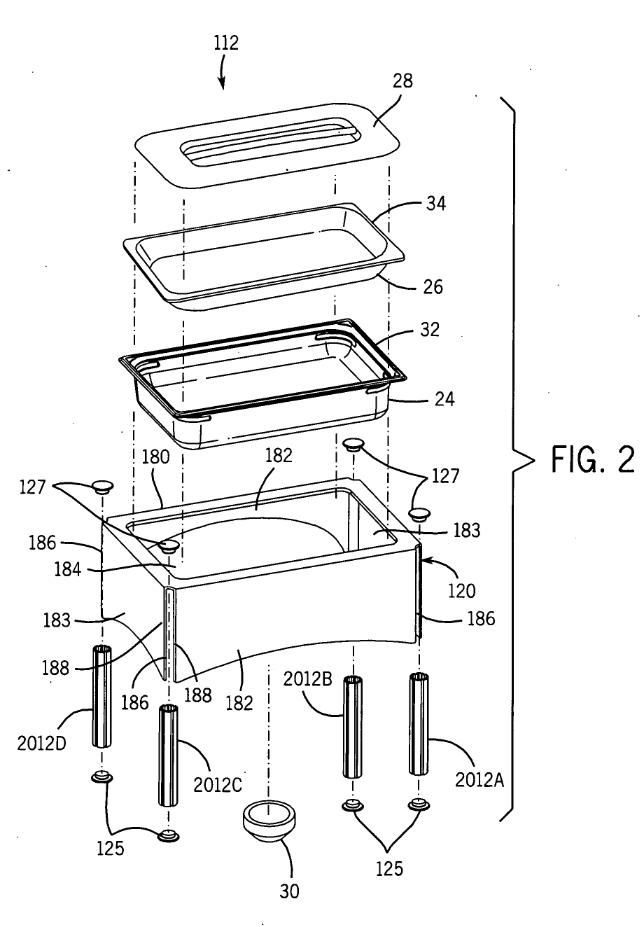

Food serving arrangement 10 generally includes food serving units 12A, 12B, 12D, 12E and 12F (collectively referred to as food serving units 12). Food serving unit 12A generally includes housing 20, legs 22A, 22B, 22C and 22D (collectively referred to as legs 22), an underlying ice/steam pan 24 (shown in FIG. 2), food pan 26, lid 28 (shown in FIG. 2) and heat source support 30 (shown in FIG. 2). Housing 20 comprises one or more structures configured to support pan 24 and/or pan 26. In particular embodiments, housing 20 is further configured to enclose and conceal heat source support 30. In the particular example illustrated, housing 20 forms a frame about a perimeter of both pans 24 and 26, wherein a rim 32 of pan 24 (shown in FIG. 2) rests upon an upper edge of housing 20 and wherein rim 34 of pan 26 rests upon rim 32. In particular embodiments in which pan 24 is omitted, rim 34 may directly rest upon housing 20. As a result, housing 20 enables one or both of pans 24 (shown in FIG. 2) and pan 26 to be lifted and separated from housing 20 for cleaning, transport or replacement. In other embodiments, one or both of pans 24 and 26 may alternatively be fastened to housing 20. In yet other embodiments, pans 24 and/or 26 may alternatively be permanently affixed or secured to housing 20 such as by welding, adhesives and the like. In some embodiments, pan 24 and/or pan 26 may be integrally formed as part of a single unitary body with housing 20.

Legs 22 comprise elongate structures coupled to housing 20 so as to support housing 20 with respect to an underlying table, counter or other supporting surface upon which legs 22 rest. In still other embodiments, legs 22 may alternatively be configured to be mounted to an inclined or vertical surface while being elevated above the ground or floor. For purposes of this disclosure, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature.

According to one example embodiment, legs 22 are removably coupled to housing 20. According to one embodiment, legs 22 are configured to be removed and separated from housing 20 without the need for tools or the manipulation of fasteners such as screws, bolts or the like. As a result, food serving arrangement 10 and food serving unit 12 may be more easily disassembled for compact storage and transportation.

In other embodiments, legs 22 may alternatively be removably fastened to housing 20 by fasteners. In other embodiments, legs 22 may be permanently joined to housing 20 such as by adhesives, welding and the like. In still other embodiments, legs 22 may alternatively be integrally formed as part of a single unitary body with housing 20. In yet other embodiments, legs 22 may alternatively be directly connected to pan 24, wherein housing 20 is supported and suspended by pan 24. Although legs 22 are illustrated as being identical to one another, in other embodiments, legs 22 may have distinct configurations. Moreover, although legs 22 are illustrated as comprising elongate generally cylindrical structures, in other embodiments, legs 22 may have other cross sectional shapes (rectangular, octagonal, triangular, square) and may alternatively be nonsymmetrical with respect to the axis along which legs 22 extend.

Pans 24 and 26 comprise basins having the aforementioned rims 32 and 34, respectively. In the particular example illustrated, pan 24 is configured to hold a medium used to maintain food within pan 26 at a desired temperature. For example, in one embodiment, pan 24 is configured to hold ice. In yet other embodiments, pan 24 may be configured to hold water which is subsequently converted to steam to heat food within pan 26. In still other embodiments, pan 24 may be configured to hold other mediums. Although pan 24 is illustrated as being rectangular, pan 24 may have other shapes. In particular embodiments, pan 24 may be omitted.

Pan 26 is configured to hold food and to present such food to persons. In the particular embodiment illustrated, pan 26 is generally imperforate. In other embodiments, pan 26 may have a perforated bottom, permitting foods or other elements to be selectively filtered or passed through pan 26 into pan 24. Although illustrated as being rectangular and as having rim 34, pan 26 may have various other configurations and may have other associated structures such as handles and the like.

Lid 28 (shown in FIG. 2) comprises a structure configured to cover the contents of pan 26 to assist in maintaining such constants at a desired temperature as well as to prevent contamination of the contents of pan 26. In other embodiments, lid 28 may be omitted. Heat source holder 30 comprises a structure configured to hold a source of heat, enabling the held source of heat to apply heat to pan 24 (shown in FIG. 2). In the particular example illustrated, heat source support 30 comprises a sterno holder configured to hold a sterno source of heat. In other embodiments, support 30 may be configured to hold other sources of heat such as electrically resistive or inductive heat sources. In yet other embodiments in which a heat source is not to be used, support 30 may be omitted.

Food serving unit 12B is similar to food serving unit 12A except that food serving unit 12B comprises a unit coupled to unit 12A and also configured to contain and present food. Like unit 12A, unit 12B is configured to be put upon a table, counter or other surface elevated above the floor or ground or to alternatively be suspended above the floor or ground and other vertical surface. Food serving unit 12B includes housing 40, legs 42A and 42B (collectively referred to as legs 42), legs 22A, 22B, and underlying ice-steam pan (not shown) and food pan 46. Housing 40 is similar to housing 20 except that housing 40 is generally arcuate shaped. Like housing 20, housing 40 has an annular upper opening into which an underlying ice/steam pan (not shown) and pan 46 are received, wherein the rim of the underlying ice/steam pan and rim 52 of pan 46 rest upon housing 40. As a result, the underlying ice/steam pan and pan 46 may be lifted and removed from housing 40 for cleaning, filling or replacement. In particular embodiments, underlying ice/steam may be omitted. Like housing 20, housing 40 further at least partially conceals those portions of the underlying ice/steam pan and pan 46 that are received within housing 40.

Legs 42A and 42B comprise elongate structures configured to support housing 40 above an underlying table, counter or other generally horizontal surface which is itself spaced or elevated above the floor or ground. In yet other embodiments, legs 42A and 42B may alternatively be configured to be mounted to a vertical or inclined surface so as to elevate food serving unit 12B above the ground or floor. Although illustrated as being substantially identical in configuration to legs 22A and 22B yet having a reduced length or height, legs 42A and 42B may alternatively have different configurations as compared to legs 22A and 22B and may have the same height or a greater height.

In the particular example illustrated, legs 42A and 42B are removably coupled to housing 40. In one particular embodiment, legs 42A and 42B are configured to be separated and removed from housing 40 without the use of tools and without manipulation of one or more fasteners. As a result, unit 12B may be more easily disassembled for transportation or storage and legs 42A, 42B may be more easily repaired or replaced as needed. In yet other embodiments, legs 42A, 42B may be removably coupled to housing 40 by one or more fasteners. In yet other embodiments, legs 42A, 42B may alternatively be affixed or permanently secured to housing 40 such as with welding, bonds, rivets and the like. In yet other embodiments, legs 42A, 42B may be integrally formed as part of a single unitary body with housing 40.

Legs 22A, 22B comprise the same legs as that of food serving unit 12A. Because food serving unit 12A and food serving unit 12B share a common pair of legs (legs 22A and 22B), food serving arrangement 10 is more compact and occupies less horizontal space. In addition, food serving arrangements 10 utilizes fewer parts and has a more simpler aesthetic appearance.

According to one embodiment, housing 40 of food serving unit 12B is removably coupled to each of legs 22A and 22B. As a result, food serving arrangement 10 is modular in nature, enabling food servicing unit 12B to be added or removed with respect to food serving unit 12A as described. In particular embodiments, legs 22A, 22B are also removably coupled to housing 20 of food serving unit 12A. In yet other embodiments, legs 22A, 22B may alternatively be permanently affixed to housing 40 while being removably connectable to housing 20.

The underlying ice/steam pan (not shown) and pan 46 are similar to pans 24 and 26, respectively, of food serving unit 12A except that such pans are arcuate in shape. In particular embodiments, the underlying ice/steam pan may be omitted. In some embodiments, food serving unit 12B may additionally include a heat source support such as heat source support 30 shown in FIG. 2.

Food serving unit 12C is substantially identical to food serving unit 12B except that food serving unit 12C shares legs 22C and 22D of food serving unit 12A instead of legs 22A and 22B. In addition to legs 22C and 22B, food serving unit 12C includes legs 42C and 42D in lieu of legs 42A and 42B. Legs 42C and 42D are substantially identical to legs 42A and 42B. Those remaining elements of food serving unit 12C which correspond to elements of food serving unit 12B are numbered similarly.

Food serving unit 12D comprises a unit configured to contain food or other items which is coupled to units 12A and 12B. In the particular example illustrated, unit 12D supports food or other contents at a height distinct from that of unit 12B which also supports food or other contents at a height distinct from that of unit 12A. As a result, units 12A, 12B and 12D provide a stair-step effect, enabling the contents of such units to be more easily viewed and accessed while reducing space requirements.

Food serving unit 12D generally includes housing 60, leg 62, legs 22A, 42A, and pan 66. Housing 60 comprises one or more structures configured to support pan 66. In the particular example illustrated, housing 60 further conceals a portion of pan 66. In one embodiment, housing 60 is similar to housing 20 and housing 40 except that housing 60 is triangular in shape. Like housing 20 and 40, housing 60 has an upper opening into which pan 66 is received, enabling housing 60 to conceal a lower portion of pan 66. At the same time, this opening enables pan 66 to be lifted and removed from housing 60 for cleaning, filling or replacement. In yet other embodiments, housing 60 may alternatively be fastened to pan 66, may be permanently affixed to or secured to pan 66 by welds, adhesives or rivets and the like or may be integrally formed as part of a single unitary body with pan 66. In other exemplary embodiments, an additional pan may be provided below pan 66 (or any of the other “upper” pans) to provide additional functionality and capabilities (e.g., an underlying ice/steam pan or the like).

Leg 62 comprises an elongate structure coupled to housing 60 and configured to support housing 60 relative to an underlying table, counter or other surface elevated above the ground or floor. In other embodiments, leg 62 may alternatively be configured to be suspended above the ground or floor rather than resting upon a surface elevated above the ground or floor. In the example illustrated, leg 62 has a similar configuration to that of legs 22A and 42A yet has a reduced height. In other embodiments, leg 62 may have a different configuration as well as a different height.

In the particular example illustrated, leg 62 is removably coupled to housing 60, enabling leg 62 to be separated or removed from housing 62 for repair or replacement. In one particular embodiment, leg 62 is configured to be separated or removed from housing 60 without the use of tools and without the need for manipulating one or more fasteners. As a result, leg 62 may be easily disassembled from housing 60. In yet other embodiments, leg 62 may be removably coupled to housing 60 by one or more fasteners. In still other embodiments, leg 62 may be bonded to housing 60 by welds, adhesives, rivets and the like. In still other embodiments, leg 62 may be integrally formed as part of a single unitary body with housing 60.

Legs 22A and 42A comprise the same legs as that of food serving unit 12A and unit 12B. As a result, the compactness of food serving arrangement 10 is further enhanced, reducing the overall surface space required for arrangement 10. The space savings of food serving arrangement 10 is especially enhanced in that a single leg 22A is shared by three food serving units 12A, 12B and 12D. In those embodiments in which food serving unit 12D is removably coupled to legs 22A and 42A, with food serving arrangement 10 as enhanced modularity in that food serving units 12A, 12B and 12D may each be selectively added or removed as needed or desired.

Food serving unit 12E is similar to food serving unit 12D except that food serving unit 12E shares legs 22C and 42C in lieu of legs 22A and 42A. Those remaining elements of food serving unit 12D which correspond to elements of food serving unit 12D are numbered similarly. Like food serving unit 12D, food serving unit 12E provides arrangement 10 with reduced space consumption by sharing legs 22C and 42C. Food serving unit 12E also provides a stair-step effect for displaying and presenting food or other contents. In those embodiments in which unit 12E is removably connected to units 12A and 12C, unit 12E provides arrangement 10 with enhanced modularity to meet varying needs.

Food pan 66 is similar to food pans 26 and 46 except that food pan 66 is generally triangular in shape. Like pans 26 and 46, pan 66 is configured to contain food and has a basin portion that is at least partially received within and concealed by housing 60. Like pans 26 and 46, pan 66 has a rim 72 which rests upon housing 60 to support pan 66 above housing 60. As a result, pan 66 may be lifted and removed for cleaning, filling or replacement. In other embodiments, pan 66 may be removably fastened to housing 60 or may be integrally formed as a single unitary body with housing 60.

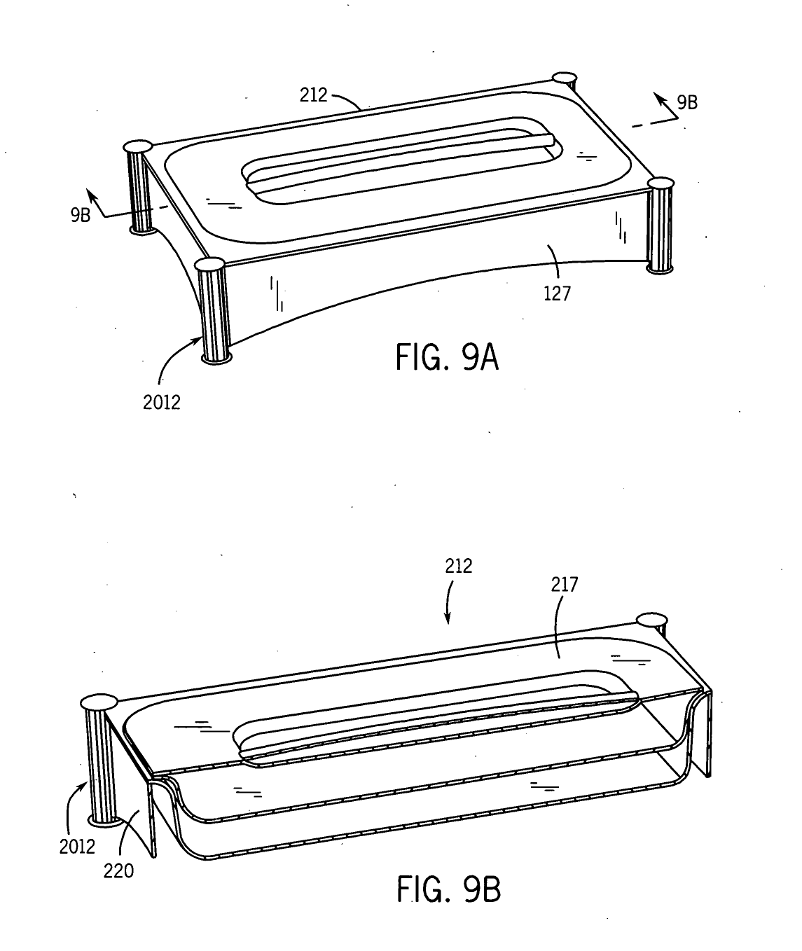

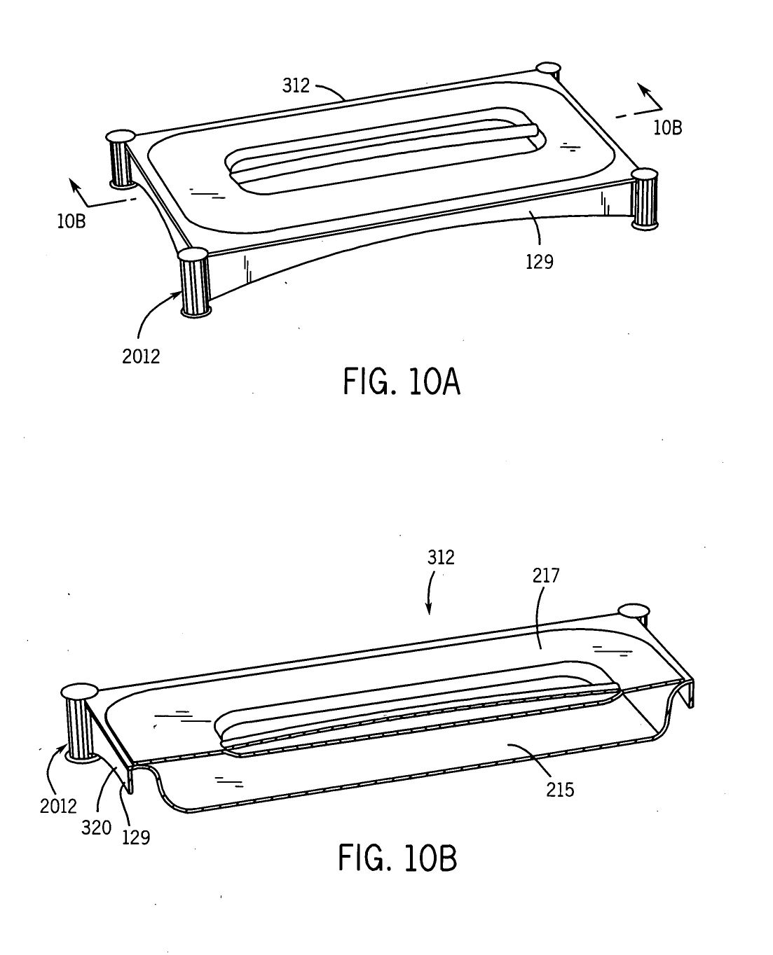

FIG. 2 is an exploded perspective view illustrating food serving unit 112, one particular embodiment of food serving unit 12A shown in FIG. 1. Food serving unit 112 is similar to food serving unit 12A except that food serving unit 112 specifically includes housing 120 and legs. The legs may be legs 2012A, 2012B, 2012C and 2012D as shown, for example, in FIGS. 2, 8A, 8B, 9A, 9B, 10A, 10B, 31, 33 (collectively referred to as legs 2012), legs 122A, 122B, 122C, 122D (collectively referred to as legs 122 in FIGS. 4-7), or other legs that are shown and/or described herein. Food serving unit 112 additionally includes feet 125 and caps 127. Housing 120 comprises a three-dimensional structure configured to support pans 24 and 26 while being supported itself by legs 2012. Housing 120 includes frame 180 and sides 182, 183. Frame 180 comprises an elongate flange or other structure forming an opening 184. Opening 184 is configured to receive a lower portion of pan 24 such that the lower portion of pan 24 is concealed by sides 182 and 183. At the same time, frame 180 supports rim 32 of pan 24 (or rim 34 or pan 26 when pan 24 is omitted), enabling pan 24 and pan 26 to be lifted from opening 184 for cleaning, filling, emptying or replacement. In other embodiments, frame 180, also known as a rim, may alternatively be fastened, fixed or integrally formed with pan 24. Those remaining elements of food serving unit 112 which correspond to elements of food serving unit 12A are numbered similarly.

Sides 182 and 183 extend non-parallel from frame 180 to form gaps or channels 186. As will be described in detail hereafter, channels 186 facilitate releasable or removable connection of housing 120 to legs (legs 122, legs 2012, or the like). In the particular example illustrated in which housing 120 is generally rectangular, sides 182 and 183 extend substantially perpendicular to one another such that channels 186 are located at the four corners of housing 120. In other embodiments, sides 182 and 183 may extend at other angles relative to one another so as to form a greater or fewer number of such channels 186. For example, in other embodiments, housing 120 may be triangular in a fashion similar to that of housing 60 (shown in FIG. 1), wherein housing 120 would alternatively have three sides forming three channels 186. Although sides 182 and 183 are illustrated as being generally flat linear or planar panels, in other embodiments, sides 182 and 183 may be non-linear or non-planar and may also be configured such that opposite sides 182 or opposite sides 183 are not parallel to one another. For example, in other embodiments, housing 120 may include sides 182 and 183 configured similar to that of the sides of housing 40 (shown in FIG. 1).

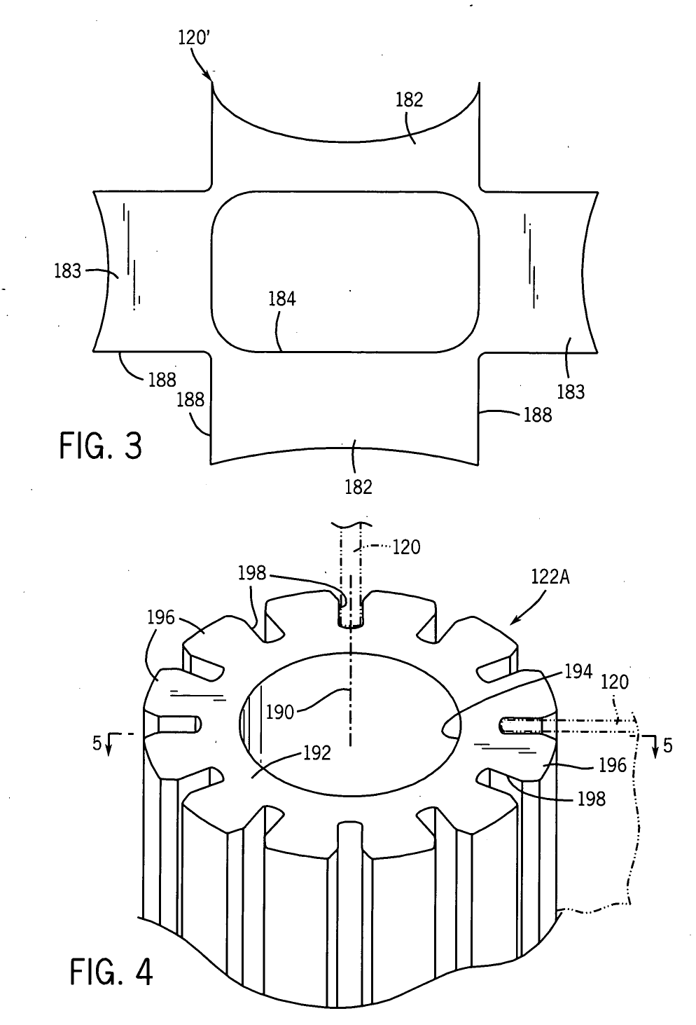

FIG. 3 illustrates one example method by which housing 120 may be formed. FIG. 3 illustrates a sheet, panel or pattern 120′ from which housing 120 is formed. In one embodiment, pattern 120′ comprises a sheet or panel of metal, such as stainless steel which is stamped or otherwise cut to the configuration shown in FIG. 3. In other embodiments, pattern 120′ may be molded or fabricated using other techniques. In lieu of being formed from stainless steel, in other embodiments, pattern 120′ may be formed from other metals or may be formed from other deformable materials.

As shown by FIG. 3, pattern 120 includes opening 184 and sides 182, 183. Sides 182 and 183 are interconnected and have consecutive edges 188. Upon deformation of pattern 120′ to form housing 120 (shown in FIG. 2), edges 188 remain spaced from one another to form channels 186 (shown in FIG. 2). The described method for forming housing 120 enables housing 120 to be easily fabricated at a low cost. In other embodiments, housing 120 may be formed from other fabrication methods.

The legs support housing 120 above an underlying table, counter or other surface which is itself elevated above the floor or ground. In other embodiments, legs 122 may merely serve as a connecting structure facilitating connection of unit 112 to other food serving units. FIG. 4 is a sectional view of leg 122A illustrating leg 122A in more detail. As shown by FIG. 4, leg 122A generally extends along axis 190 and includes hub 192, opening 194, fingers 196 and channels or grooves 198. Hub 192 comprises that portion of leg 122A extending about opening 194 and supporting fingers 196. Hub 192 comprises the structure strength of leg 122A while providing opening 194. Opening 194 provides a cavity for receiving and connecting feet 125 to a lower end of leg 122A and for receiving and connecting a portion of cap 127 to leg 122A. In the particular example illustrated, opening 194 extends along an entire axial length of leg 122A. In other embodiments, opening 194 may be located at both a top and a bottom of leg 122A. In still other embodiments, opening 194 may have other configurations or may be omitted where other methods are utilized for connecting foot 125 and cap 127 to leg 122A. In particular embodiments where one or both of foot 125 and cap 127 are omitted, opening 194 may be omitted either at the bottom or top of leg 122A.

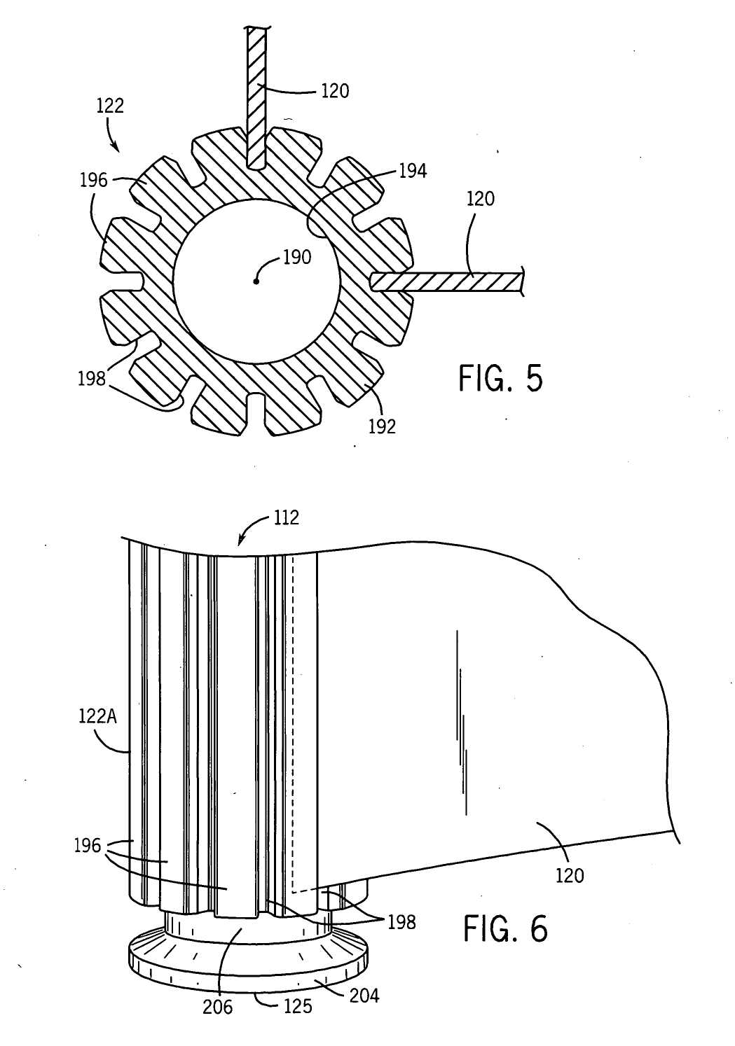

Fingers 196 extend radially outward from hub 192 and are spaced from one another so as to form grooves 198. Fingers 196 and grooves 198 cooperate to serve as connection portions for leg 122A by receiving respective edges 188 of sides 182 and 183 of housing 120 as best seen in FIG. 5. In the particular example illustrated, as shown in FIG. 5, housing 120 is connected to leg 122A by aligning a lower portion of edges 188 with respective grooves 198 and sliding edges 188 into and along grooves 198. As a result, leg 122A may be secured to housing 120 without additional fasteners or without the need for tools. At the same time, housing 120 is securely connected to leg 122A.

In the particular example illustrated, leg 122A includes fingers 196 and grooves 198 at a plurality of circumferential positions about axis 190. As a result, leg 122 may be simultaneously connected to multiple distinct housings such as housing 120 shown in FIG. 2 or such as housings 40 and 60 shown in FIG. 1, when such housings 40 and 60 have edges 188 and channels 186 similar to that of housing 120. As a result, leg 122A may be utilized to connect multiple food serving units, wherein such food serving units share leg 122A to reduce space consumption and minimize part count and set up costs. Moreover, because the connection portions provided by fingers 196 and grooves 198 are angularly spaced from one another about axis 190, such interconnected food serving units may also be positioned at a variety of angular positions with respect to one another including non-parallel and non-perpendicular angular positions with respect to one another.

In the particular example illustrated, leg 122A includes fingers 196 and grooves 198 which continuously circumferentially extend about axis 190 to facilitate interconnection of food serving units at a multitude of relative angular positions with respect to one another. In other embodiments, leg 122A may alternatively have fingers 196 and grooves 198 non-uniformly positioned about axis 190. For example, in other embodiments, leg 122A may be specifically configured to be connected to a set number of housings or to connect such housings at a predetermined selected angles with respect to one another. In still other embodiments, leg 122A may have other structures configured to facilitate movable connection of multiple food serving units to one another about or with respect to axis 190. For example, in lieu of having channels 198 that receive portions of housing 120, in other embodiments, housing 120 may include a channel configured to receive a corresponding male projection extending from leg 122A. In particular embodiments, edges 188 may have bulbous or rounded cylindrical ends which slide within corresponding cylindrical grooves 198 to enhance mating of such housings with leg 122A.

According to one example embodiment, leg 122A is formed from a polymer. In other embodiments, leg 122A may be formed from a metal. Due to its symmetrical configuration about axis 190, leg 122A may be extruded to reduce the fabrication costs. In other embodiments, leg 122A may be formed from other materials and other fabrication methods. For example in other embodiments, leg 122A may be formed from wood or combinations of multiple materials.

In other embodiments, leg 122A may have other male and female interlocking structures.

Legs 122B, 122C and 122D are substantially identical to leg 122A. According to one embodiment, each of legs 122A-122D is configured so as to have a length or height such that a top end of each leg 122 extends in close proximity to frame 180 of associated housing (housing 120) assembled and supporting the associated housing. In the particular example illustrated, legs 122 each have a height or length less than or equal to about 2 feet. In one embodiment, each leg has a height or length less than or equal to about 12 inches. As a result, legs 122 do not substantially project well beyond frame 180 so as to interfere with axis to food contained within the food serving unit. When supporting housings having a lesser height, legs 122 are further shortened depending upon the height of the particular food serving unit of the adjacent particular food serving unit. For example, in embodiments where legs 42 of food serving unit 12B are configured in a manner similar to that of legs 122, legs 42 also have a height such that the top of legs 42 are in close proximity to a top of housing 40. In one example embodiment, legs 42 have a height of less than or equal to about six inches. In those embodiments in which legs 62 of food serving units 60 are configured in a manner similar or identical to that of legs 122, legs 62 have a height of less than or equal to about three inches. In those embodiments in which legs 22 of food serving units are configured in a manner similar or identical to that of legs, legs 22 have a height of less than or equal to about nine inches. Such lengths facilitate the positioning of food serving arrangement 10 or any other food serving arrangement including legs similar to that of legs 122 to be positioned upon a table, counter or other horizontal surface elevated above the floor or ground while providing persons a relatively unobstructed view and access to food displayed and contained by the various food serving units of the food serving arrangement. In alternative embodiments, the legs may extend above the top surface of the housing and/or the pan.

Feet 125 comprise structures configured to be connected to a lower end of each of legs 122 so as to stably support legs 122 upon a surface such as a table or countertop. FIG. 6 illustrates one of feet 125 connected to one of legs 122. As shown by FIG. 6, each foot 125 has an enlarged base portion 204 and reduced diameter boss 206. Base 204 rests upon a surface such as a table or counter while boss 206 projects into opening 194 of leg 122A to a close frictional fit with the interior of opening 194. In other embodiments, foot 125 may additionally be secured to leg 122 by adhesives, welding or fasteners. In addition to supporting leg 122 above a surface, foot 125 further engages a lower end of housing 120 to limit the downward movement of housing 120 relative to leg 122A so as to control the height of housing 120 above the table, counter or other surface upon which food serving unit 112 rests. In yet other embodiments, foot 125 may be omitted.

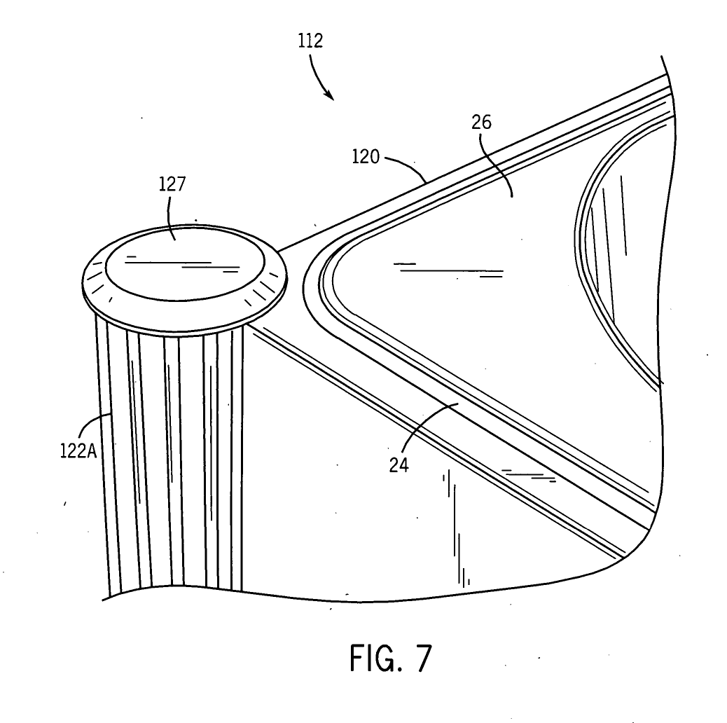

As shown by FIG. 7, caps comprise structures configured to connect to an upper end of legs 122. As shown by FIG. 7, each cap is partially received within opening 194 of leg 122 and projects above and beyond leg 122. Each cap 127 covers opening 194 and assists in retaining housing 120 in connection with leg 122A. To separate housing 120 from leg 122A, cap 127 connected to leg 122A is lifted and removed and housing 120 is lifted relative to leg 122A so as to slide edges 188 (shown in FIG. 3) from grooves 198 (shown in FIG. 4). In other embodiments, caps 127 may be omitted.

Overall, food serving unit 112 provides a unit that may be broken down and disassembled without tools and without manipulation of one or more fasteners. Likewise, food serving unit 112 may be quickly and easily assembled at a site or when needed. In the particular example illustrated in which housing 120 is formed from deformed sheets of polymeric or metal material and when legs 122 are extruded, unit 112 is manufactured at a reduced cost. Moreover, legs 122 enable unit 112 to be quickly and easily joined to other food serving units in a variety of different relative angular positions and at different heights to form an aesthetically attractive and highly functional food serving arrangement such as food serving arrangement 10 shown in FIG. 1. In addition, food serving arrangement 112 may be modified so as to support single pan 26 or additional pans such as pan 24 at various desired heights so as to present food and so as to maintain food at, above or below room temperature.

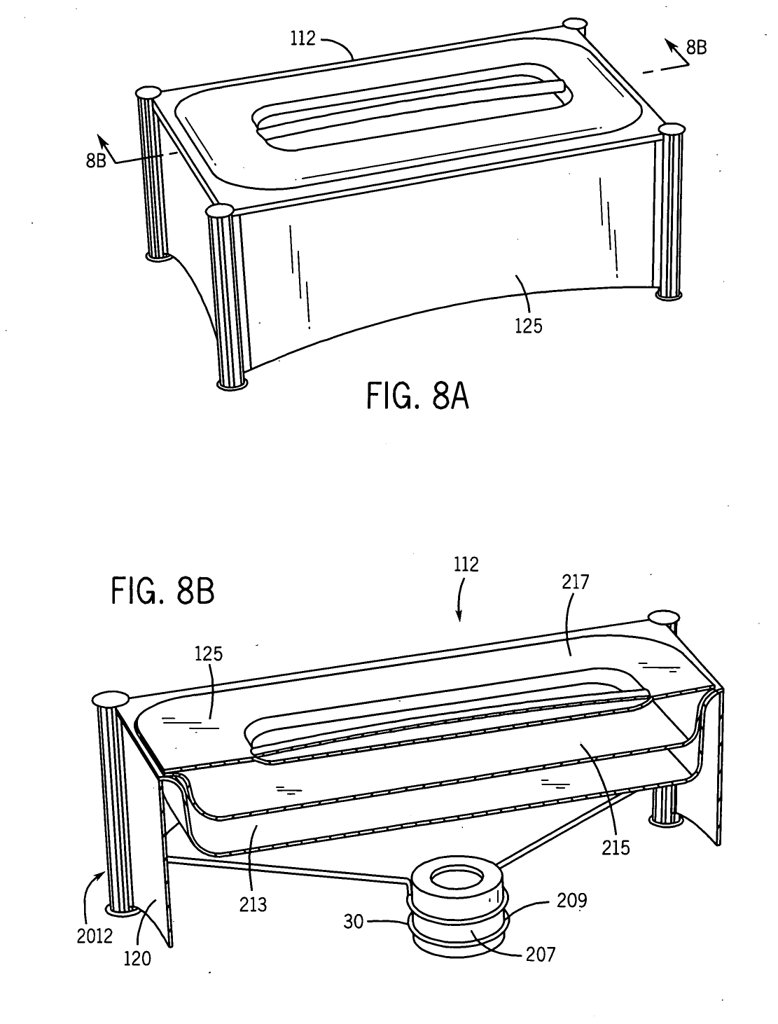

FIGS. 8A, 9A and 10A are perspective views illustrating food serving units 112, 212 and 312, respectively. FIGS. 8B, 9B and 10b are sectional views of units 112, 212 and 312, respectively. Food serving unit 112 is described above with respect to FIGS. 2-7. FIG. 8B additionally illustrates a heat source (shown as a sterno 207) positioned within heat source holder 30.

Food serving unit 212 is similar to food serving unit 112 except that food serving unit 212 includes housing 220 and legs 222 in lieu of housing 120 and legs 122. Housing 220 is similar to housing 120 except that housing 220 has sides with a reduced height. Likewise, legs 222 are similar to legs 122 except that legs 222 have a correspondingly reduced height. In the example illustrated, legs 122 of unit 112 have a height sufficient so as to elevate pan 24 above a heat source, such as heat source 207. Legs 222 have a height sufficient so as to elevate pan 24 above the underlying table or counter surface. As a result, unit 112 is well suited for containing food that must be maintained at a temperature above room temperature, wherein heat from heat source 207 heats water within pan 24 and the converted steam maintains food within pan 26 at the elevated temperature. In contrast, unit 212 is well suited for maintaining food at a temperature below room temperature, wherein pan 24 may contain ice for cooling contents of pan 24.

Food serving unit 312 is similar to food serving unit 112 except that food serving unit 312 omits pan 24, and includes housing 320 and legs 322 in lieu of housing 120 and legs 122. Housing 320 is similar to housing 120 except that housing 320 has a reduced height. Likewise, legs 322 are similar to legs 122 except that legs 322 also have a reduced height. Legs 322 have a height sufficient so as to elevate pan 34 above the underlying table or counter surface. Because legs 322 do not need to elevate pan 24, which is omitted, legs 322 may have such a reduced height. As a result, unit 312 is well suited for containing food that need not necessarily be heated or cooled while being provided.

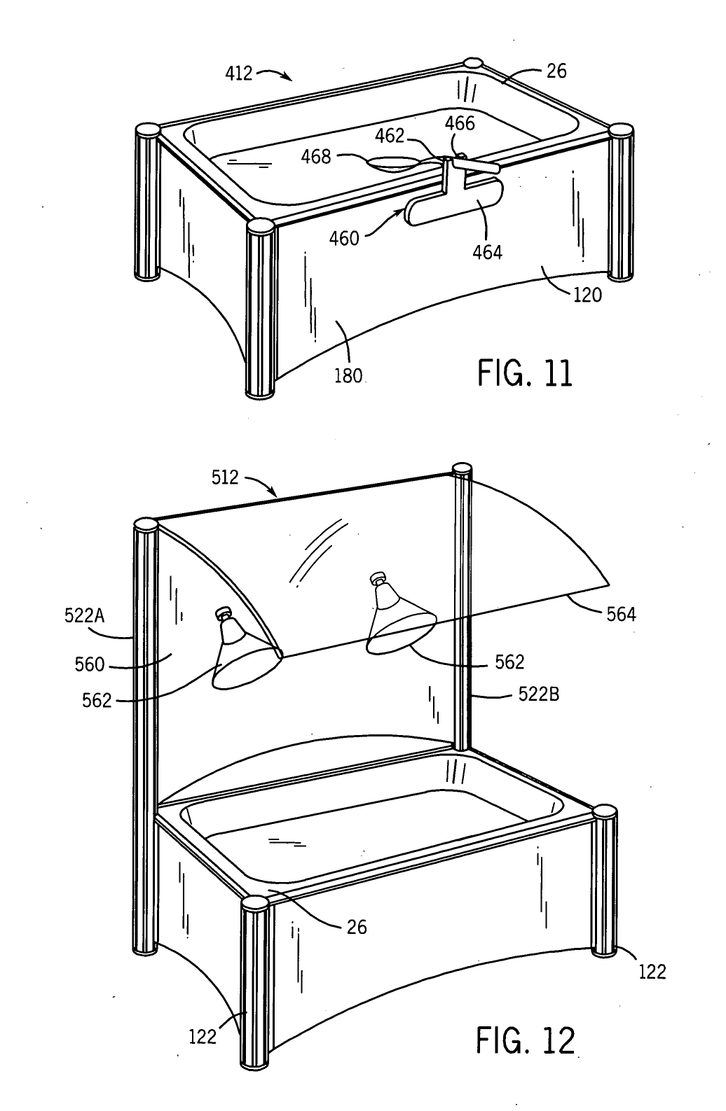

FIG. 11 illustrates food serving unit 412, another embodiment of food serving unit 112. Food serving unit 412 is similar to food serving unit 112 except that food serving unit 412 additionally includes a removable accessory and utensil rest 460. Utensil rest 460 includes a hook portion 462 and a label portion 464. Hook portion 462 comprises a generally U-shaped structure configured to extend over the rim and over a perimeter of pan 26 so as to be hung along the side of pan 26. Hook portion 462 includes a channel 466 configured to receive a handle of a utensil such as the illustrated spoon 468. As a result, the utensil is less likely to fall into the contents of pan 26. Although utensil rest 460 is illustrated as supporting a spoon, rest 460 may alternatively be configured to support other utensils such as knives, ladles and the like.

Label portion 464 is coupled to hook portion 462 and extends along a side of housing 120. Label portion 464 is configured to support or provide a surface upon which a label or other indicia may be written, affixed or otherwise formed describing the characteristic associated with the contents of pan 26 (e.g., temperature, type of food, brand name, time placed in the pan, or the like).

FIG. 12 illustrates food serving unit 512, another embodiment of food serving unit 112. Unit 512 is similar to unit 112 except that unit 512 includes legs 522A and 522B in lieu of legs 122B and 122D. Unit 512 additionally includes back support 560, lights 562 and overhang 564. Legs 522A and 522B are similar to legs 122B and 122D except that legs 522A and 522B are longer such that legs 522A and 522B substantially project above pan 26 so as to support back 560 in an inclined or vertical orientation above pan 26. In the particular example illustrated, legs 522A and 522B extend above pan 26. In particular embodiments, legs 522A and 522B may additionally support overhang 564.

Back 560 comprises a largely 2-dimensional structure suspended, hanging or otherwise supported between legs 522A and 522B. In one embodiment, back 560 may be formed from an opaque material such as metal, polymer or cellulose panel. In particular embodiments, back 560 has a thickness sufficiently thin and a sufficient rigidity such that back 560 may be slid within opposite grooves 198 of legs 522A and 522B so as to be held in place prior to positioning of caps 127 upon legs 522A and legs 522B. In one embodiment, back 560 may include alphanumeric symbols, graphics, or other color or art work describing characteristics of the contents of pan 26. In particular embodiments, back 560 additionally serves as a splash guard to reduce the trajectory of food or other contents being removed from pan 26. In the particular example illustrated, back 560 additionally supports lights 560 and any electrical circuitry, componentry or wiring associated with lights 562. In the example illustrated, back 560 also supports overhang 564.

Lights 562 comprise elements configured to emit electromagnetic radiation upon the contents of pan 26. In one embodiment, lights 562 emit visible light so as to enhance viewing of such contents. In yet another embodiment, lights 562 may alternatively or additionally emit infrared light or other electromagnetic radiation so as to cause the heating of contents of pan 26. In still other embodiments, elements 562 may be omitted. Overhang 564 comprises an elongate panel or other structure extending over and above pan 26 and its contents. In one embodiment, overhang 564 is directly connected to and supported by backing 560. In yet other embodiments, overhang 564 may be directly connected and supported by legs 522A, 522B. In one embodiment, overhang 564 is transparent or translucent so as to permit the contents of pan 26 to be viewed from above while being substantially imperforate so as to block airborne contaminants from falling upon the contents of pan 26. In such an embodiment, overhang 564 serves as what may be known as a breath guard. In still other embodiments, overhang 564 may be opaque and/or may include alphanumeric symbols or graphics. In still other embodiments, overhang 564 may be omitted.

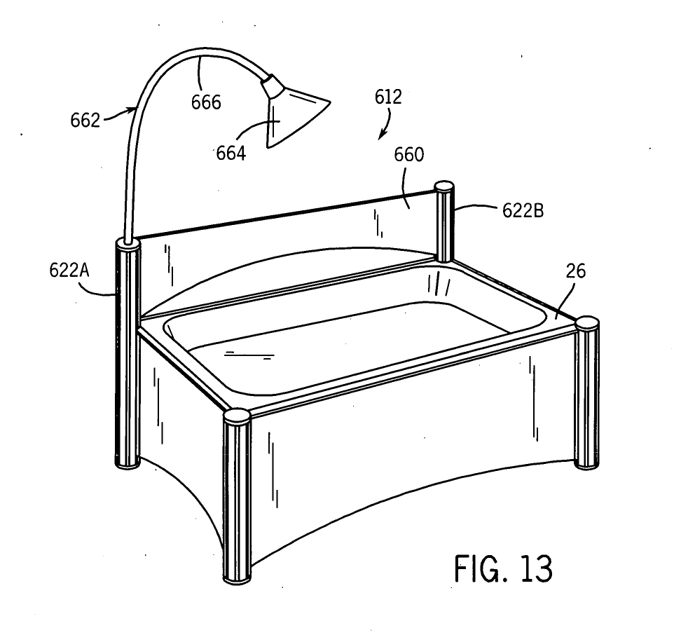

FIG. 13 illustrates food serving unit 612, another embodiment of food serving unit 112. Food serving unit 612 is similar to food serving unit 512 except that food serving unit 612 includes legs 622A, 622B, backing 660 and lighting element 662 in lieu of legs 522A, 522B, backing 560 and lighting elements 562, respectively. Legs 622A and 622B are similar to legs 522A and 522B except that legs 622A and 622B are shorter in length. Backing 660 is similar to backing 560 except that backing 660 has a reduced height and does not support lighting elements. Like backing 560, backing 660, in one embodiment, comprises an elongate panel or sheet having edges which are slid within grooves 198 (shown in FIG. 4) of legs 622A and 622B, whereby backing 660 is supported above pan 26. In one particular embodiment, backing 660 additionally includes alphanumeric symbols or graphics communicating information about the contents of pan 26 or other information.

Lighting element 662 comprises an element configured to emit electromagnetic radiation at the contents of pan 26. Light element 662 is directly connected to and supported by one of legs 622A and 622B. In other embodiments, lighting element 662 may be directly connected to and supported by backing 660 or other structures. In the particular example illustrated, lighting element 662 includes a head portion 664 and a bendable or deformable neck portion 666. Because neck portion 666 is bendable or deformable, head portion 664 may be repositioned with respect to the contents of food 26 to vary the degree or extent to which the electromagnetic radiation, such as visible light or heat, are directed at the contents of pan 26. In other embodiments, light element 662 may be omitted.

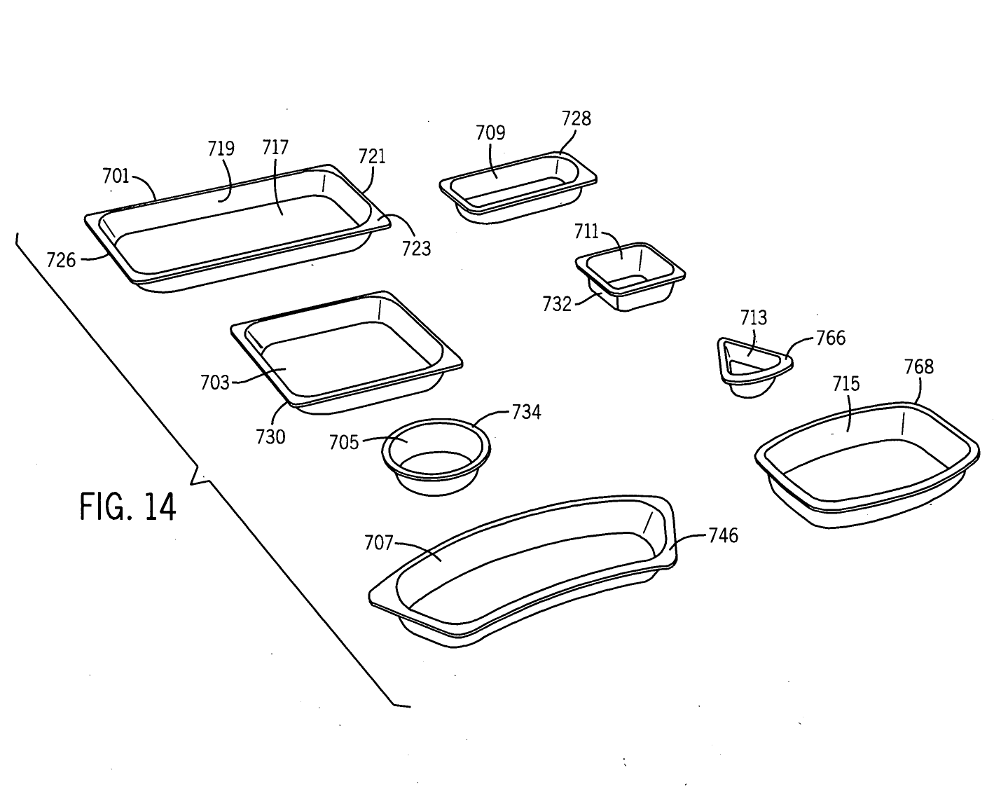

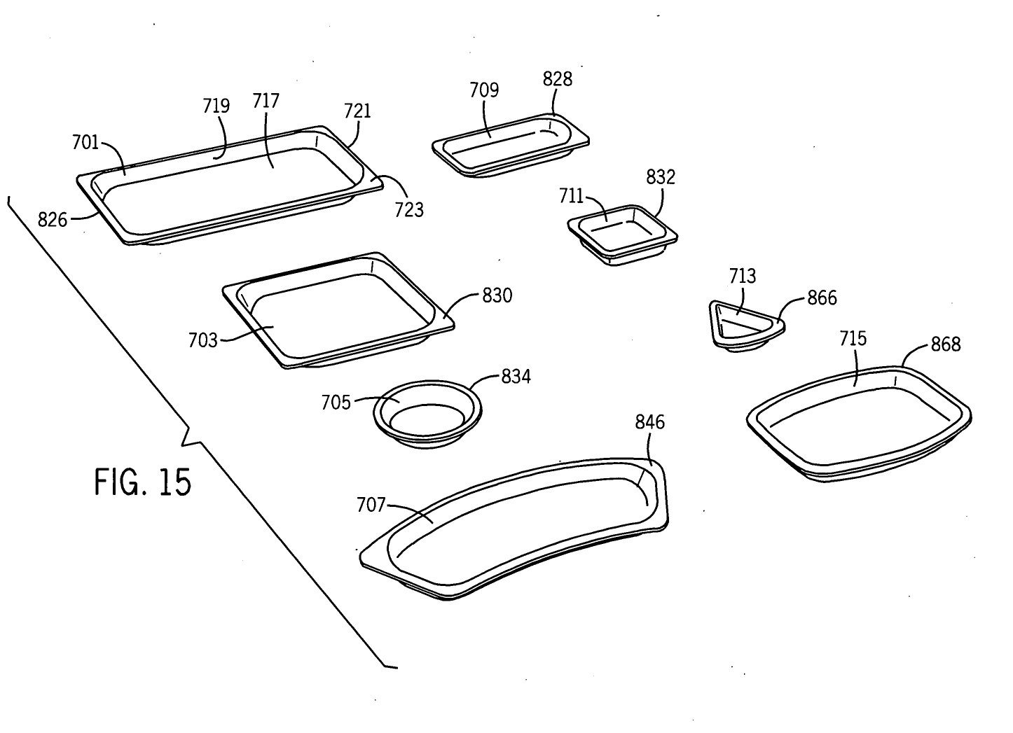

FIGS. 14 and 15 illustrate various examples of pans that may be used with food serving units such as food serving units 12 or 112 as either the upper pan for containing food or a lower pan for containing water (a steam pan) or ice. In particular, FIG. 14 illustrates pans 726, 728, 730, 732, 734, 746, 766 and 768. Pans 726-732 are generally rectangular or square in shape. Pan 734 is circular in shape, pans 746 is curved. Pan 76 is triangular. Pan 76 is generally oblong. In particular embodiments, pan 746 has an inner radius which substantially corresponds to an outer radius of pan 768. As will be described in detail hereafter, such configuration enables food serving units including pans 746 and 768 to be positioned adjacent one another in a complementary fashion. The assortment of shapes provided by pans 726, 728, 730, 732, 734, 746, 766 and 768 facilitates a multitude of distinct, unique designs that may be assembled using modular food serving units.

FIG. 15 illustrates pans 826, 828, 830, 832, 834, 846, 866 and 868. Such pans are substantially identical to those pans illustrated in FIG. 14 except that such pans have a shallower depth. Like those pans illustrated in FIG. 14, the pans illustrated in FIG. 15 facilitate multiple aesthetically attractive designs using modular food serving units. In addition, such configurations provide such pans provide such pans with attractive aesthetic appearances.

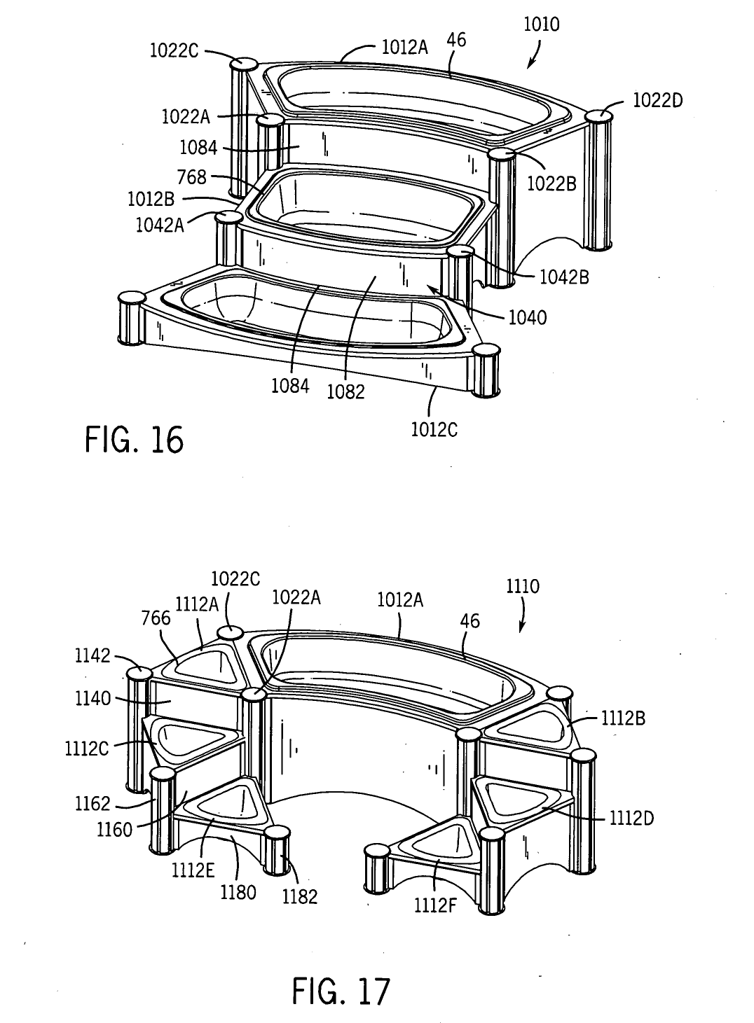

FIGS. 16-19 illustrate various examples of food serving arrangements 1010, 1110, 1210, and 1510. Those components of such food serving arrangements which correspond to previously described components are numbered similarly. Food serving arrangement 1010 generally includes food serving units 1012A, 1012B and 1012C (collectively referred to food serving units 1012) releasably connected to one another. Food serving unit 1012A is similar to food serving unit 12B in overall shape. Food serving unit 1012A shares legs 1022A and 1022B with food serving unit 1012B. As shown by FIG. 16, food serving unit 1012B includes housing 1040, legs 1042A, 1042B, 1022A, 1022B and pan 768. Housing 1040 is similar to that of housing 120 except that housing 1040 is oblong shaped. In the particular example illustrated, housing 1040 includes two opposite convex sides 1082. Convex sides 1082 generally extend parallel to and complement corresponding concave sides 1084 of food serving units 1012A and 1012C. As a result, food serving arrangement 1010 is more compact and utilizes less surface space.

Food serving unit 1012C is similar to food serving unit 1012A except that food serving unit 1012A has a reduced height as compared to food serving unit 1012A. In the particular example illustrated, food serving unit 1012C has a reduced height as compared to food serving unit 1012B. As a result, food serving arrangement 1010 has a stair-stepped configuration providing improved viewing of the contents of food serving units 1012A, 1012B and 1012C. In other embodiments, food serving units 1012A, 1012B and 1012C may have similar heights or may have other combination of different heights.

In the particular example illustrated, food serving units 1012A and 1012B share legs 1022A and 1022B while food serving units 1012B and 1012C share legs 1042A and 1042B. According to one embodiment, each of legs 1022A, 1022B and each of legs 1042A, 1042B are configured similar to that of legs 122 of food serving unit 112. As a result, food serving units 1012A, 1012B and 1012C may be separated from one another for cleaning, repair or to reduce the size of food serving arrangement 1010. In addition, such food serving units may be selectively added or removed to provide a desired overall food serving arrangement. In other embodiments, food serving units 1012A, 1012B and 1012C may be permanently joined to one another by fasteners, welds, bonds and the like.

FIG. 17 illustrates food serving arrangement 1110, another embodiment of food serving arrangement 10 shown in FIG. 1. Food serving arrangement 1110 includes food serving units 1012A, 1112A, 1112B, 1112C, 1112D, 1112E and 1112F. Food serving unit 1012A is described above with respect to food serving arrangement 1010. Food serving unit 1112A includes housing 1140, legs 1142, 1022A, 1022C and food pan 766. Housing 1140 is similar to housing 1160 and food serving arrangement 10 except that housing 1140 has an increased height. Housing 1140 is interconnected to food serving unit 1012 by shared legs 1022A, 1022C. Housing 1140 is further supported by leg 1142. Housing 1140 supports pan 766 at a height similar to that of pan 46 of food serving unit 1012A. Like pan 66 of food serving unit 12D, pan 766 is removably received within housing 1140 so as to be liftable from housing 1140.

Food serving unit 1112B is substantially similar to food serving unit 1112A except that food serving unit 1112B is connected to food serving unit 1012A on an opposite side thereof. Like food serving unit 1112A, food serving unit 1112B shares a common pair of legs, reducing the surface area consumption of food serving arrangement 1110. Food serving units 1112A and 1112B cooperate to continue the display of food at the elevated height by food serving unit 1012A so as to form a semi-circle or arc. As a result, food serving units 1112A and 1112B fit as part of a compact arrangement with food serving unit 1012A.

Food serving units 1112C and 1112D are similar to food serving unit 1112A except that food serving units 1112C and 1112E have housings 1160 and 1180 with a reduced height and are supported by legs 1162 and 1182 also having a reduced height. Each of food serving units 1112C and 1112E share a pair of legs of a proceeding adjacent food serving unit so as to conserve space. Food serving units 1112D and 1112F are similar to food serving units 1112C and 1112E, respectively, and are coupled to one another so as to provide a continuous multi-level stair-step display and presentation of food or other contents.

In the particular example illustrated, each of the legs of food serving arrangement 1110 are configured similar to that of legs 122 of food serving arrangement 112. As a result, each of the food serving units of food serving arrangement 1110 may be selectively added or removed to provide a desired overall arrangement. In the particular example illustrated, such food serving units are separable from one another without the need for tools or manipulation of one or more fasteners. In other embodiments, such food serving units may be releasably coupled to one another by fasteners or may be permanently joined to one another by welding, bonds, rivets and the like.

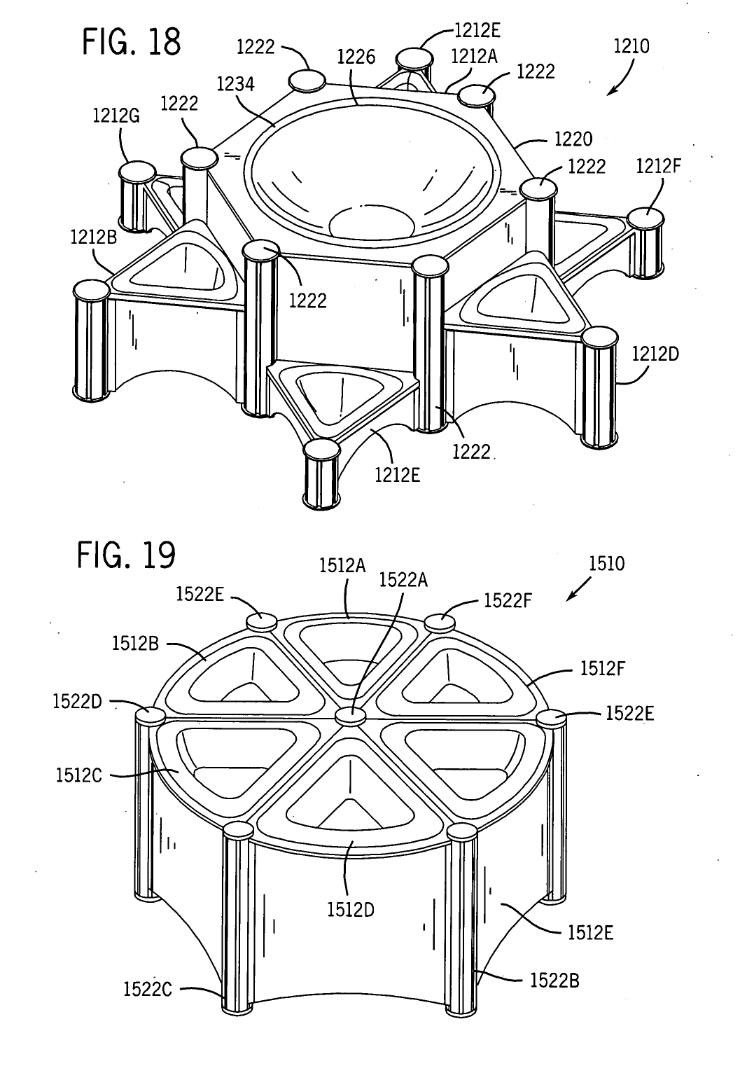

FIG. 18 illustrates food serving arrangement 1210, yet another embodiment of food serving arrangement 10. Food serving arrangement 1210 includes food serving units 1212A, 1212B, 1212C, 1212D, 1212E, 1212F, and 1212G. Food serving arrangement 1210 includes housing 1220, legs 1222 and pan 1226. Housing 1220 comprises one or more structures configured to support pan 1226. In particular embodiments, housing 1220 is further configured to enclose and conceal a heat source supported by a heat source support such as heat source support 30 (shown in FIG. 2). In one embodiment, housing 1220 is formed from a single sheet of material, such as stainless steel or a polymer shaped into a pattern and deformed into the 3-dimensional shape of housing 1220 shown. Like housing 120 of food serving unit 112, in one embodiment, housing 1220 may include channels that junctions between adjacent sides whereby housing 1220 is connected to legs 1222 in those applications in which food serving arrangement 1210 includes legs 1222 configured similar to that of legs 122. Housing 1220 further includes a circular opening (concealed) into which pan 1226 is partially lowered such that rim 1234 of pan 1226 rests upon an upper portion of housing 1220. In other embodiments, housing 1220 may be formed from other materials and may have other configurations.

Legs 1222 are substantially similar to legs 122 of food serving unit 112. Legs 1222 are removably connected to housing 1220 to facilitate removal of connection of other food serving units such as food serving units 1212B-1212F. In the particular example illustrated, housing 1220 is a generally hexagonal shape utilizing six legs 1222. In other embodiments, housing 1220 may have other shapes requiring greater or fewer number of such legs.

Pan 1226 comprises a generally circular bowl resting upon and partially within housing 1220. As a result, pan 1226 may be lifted and removed for cleaning, emptying, filling or replacement. In other embodiments, pan 1226 may be fastened to housing 1220, may be permanently joined to housing 1220 by welds, rivets, adhesives and the like, or may be integrally formed as a part of a single unitary body with housing 1220.

Food serving units 1212B-1212F are substantially similar to one another except that units 1212B, 1212C and 1212D have a height greater than the height of units 1212E, 1212F and 1212G. Each of units 1212B-1212G radially extends outward from unit 1212A. As a result, units 1212A may be centered upon a support surface and food or contents of arrangement 1210 may be accessed substantially 360 degrees about unit 1212A. In the particular example illustrated, each of units 1212B-1212G is removably connected to unit 1212A. In the particular example illustrated, each of units 1212B-1212G share a pair of legs 1222 of unit 1212A to conserve space and reduce complexity. In the particular example illustrated, each of units 1212B-1212G have corners including grooves 186 (shown in FIG. 2) which are slidably received within channels 198 of legs 1222. As a result, such units are easily separable from unit 1212A. In other embodiments, units 1212B-1212G may alternatively be fastened to unit 1212A, bonded, welded or otherwise adhered to unit 1212A or integrally formed as part of a single unitary body with unit 1212A.

FIG. 19 illustrates food serving arrangement 1510, another embodiment of food serving arrangement 10. Food serving arrangement 1510 includes food serving units 1512A-1512F. Food serving units 1512A-1512F are substantially identical to one another and share common leg(s) 1522. As a result, food serving units 1512A-1512F may be arranged in a more compact, space conserving layout. In the particular example illustrated, each unit 512A, 512F shares a leg with an adjacent unit. For example, unit 1512A shares leg 1512E with food serving unit 1512B and shares leg 1522F with unit 1512F. Outer legs 1522B-1522F further stabilize and secure the connection between units 1512A-1512E. In other embodiments, the outer legs 1522B-1522F may be omitted. In the particular example illustrated, each of legs 1522A-1522F is identical and includes multiple connection portions by which adjacent units may be interconnected. In the particular example illustrated, each of legs 1522 is substantially identical to leg 122 of food serving unit 112 (shown and described with respect to FIG. 2). In such an embodiment, each unit has a housing with adjacent edges which slides into the grooves in such legs. In other embodiments, units 1512A-1512F may be releasably interconnected by other connection mechanisms. In still other embodiments, such units may be fastened to one another with one or more fasteners or may be permanently joined to one another by welds, rivets or adhesives.

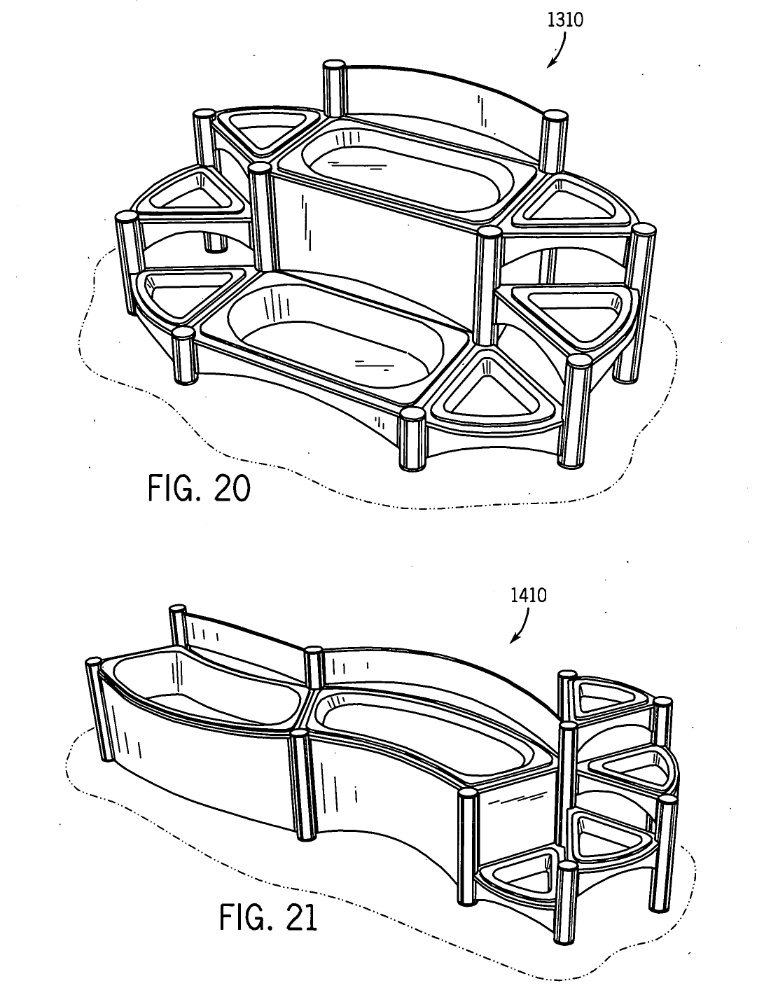

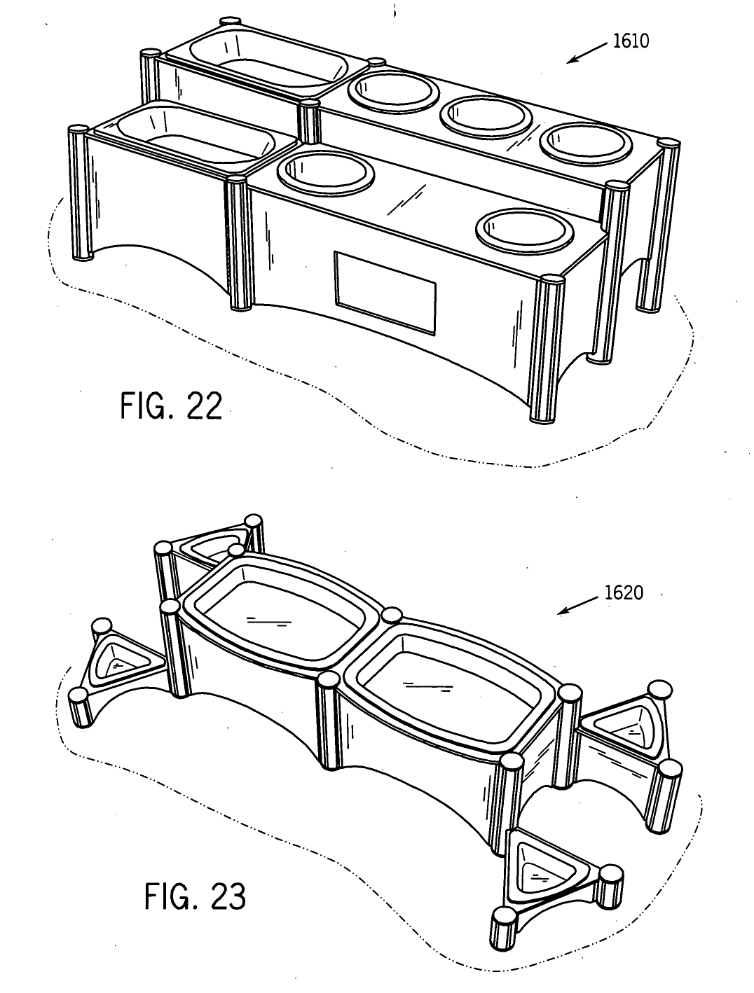

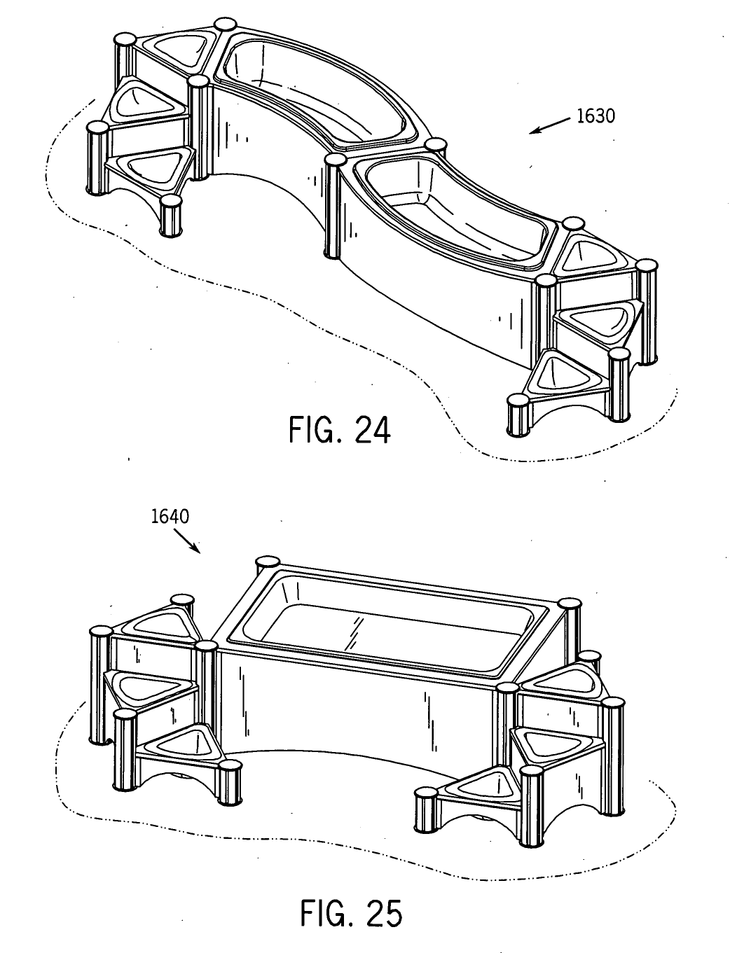

FIGS. 20-30 illustrate various other food serving arrangements of food serving arrangements 1310, 1410, 1610, 1620, 1630, 1640, 1680, 1710, 1810, and 1910. In particular embodiments, such food serving arrangements have food serving units that are releasably connected to one another in the same fashion as described above with respect to food serving unit 1010 (shown in FIG. 16) in that multiple units share legs and include housings having corners with opposite edges that are slidably received within grooves of such interconnecting and shared legs. FIGS. 20-30 illustrate the design flexibility afforded by the modular nature of such food serving arrangements and their food serving units. Because such food serving arrangements may be achieved by selectively disconnecting and connecting components such as shared legs, housing units, pans, backings and the like, a multitude of various designs are achievable using fewer individual customized components or parts, reducing complexity and cost. Such designs may be configured to satisfy numerous food serving needs. In particular embodiments, such containers may additionally be used to contain other food service condiments or accouterments. For example, in other embodiments, such containers may be used to contain napkins, eating utensils and the like. In yet other embodiments, such pans or units may be used to contain and present other non-food items unrelated to food.

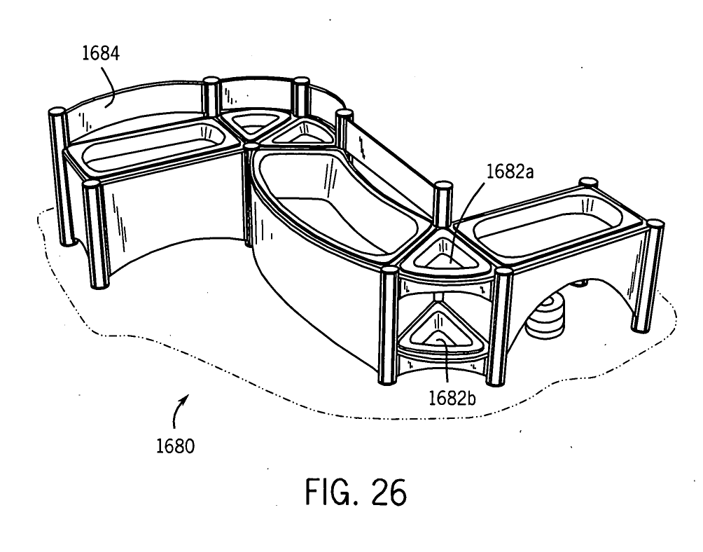

FIG. 26 is a perspective view of a food arrangement system 1650 such that the housing units bend around comers. Housing unit 1680 includes pan 1682a positioned above pan 1682b, intended to maximize food serving capabilities in a limited space. Housing unit 1680 includes a splash guard 1684 located on the back side of a plurality of housing units. Splashguard 1684 is complementary to the curve of a plurality of housing units it connects to via the corresponding legs of the housing units. Splash guard 1684 is removable. Splashguard 1684 is 1-12 inches tall. In other embodiments, splashguard 1684. An alternative embodiment includes attaching splash guard made of materials such as plastic or wood, and permanently attached to legs via welding or adhesive.

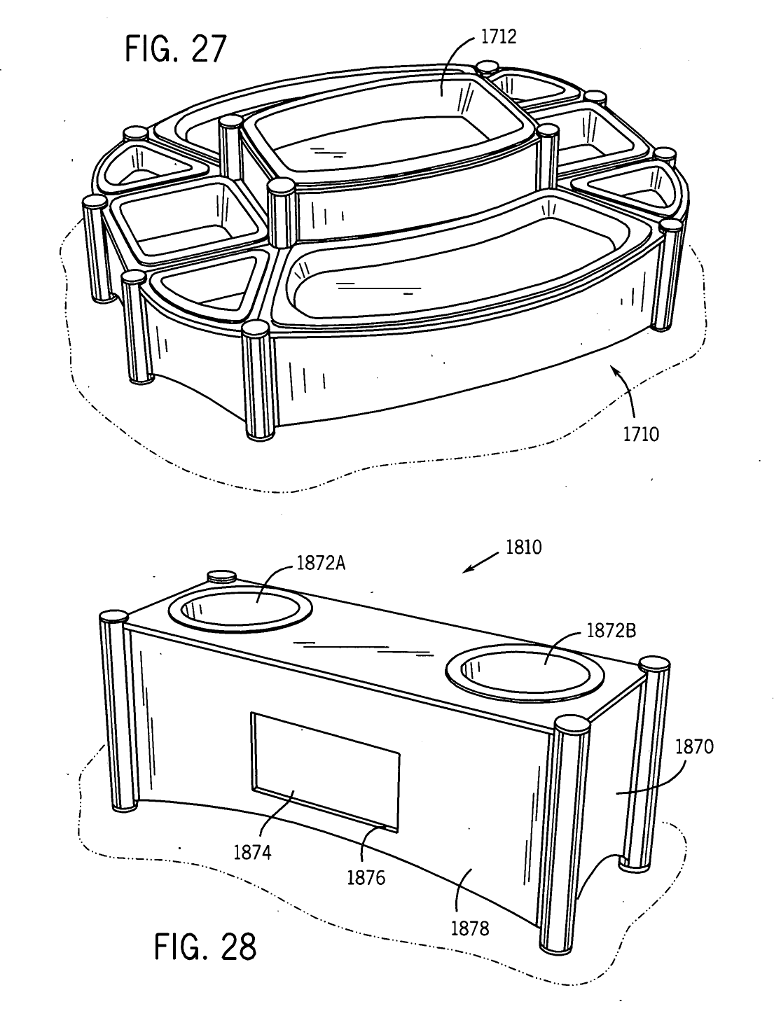

FIG. 27 is a perspective view of a two-sided food arrangement system 1710. A center housing unit 1712 intended for hot or cold food is connected to curved, square, and triangular housing units on each sides.

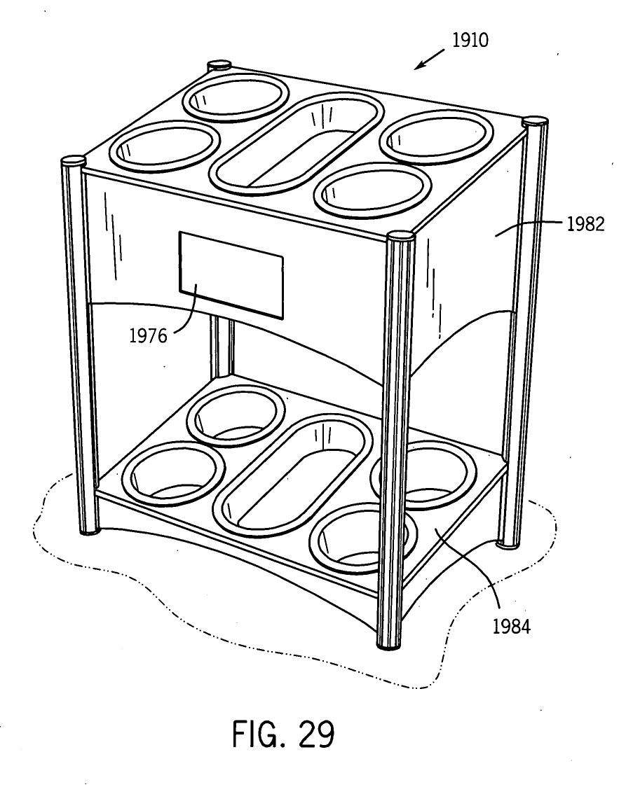

FIG. 28 is a perspective view of optional accessories for food serving arrangement 1810 consisting of a housing unit 1870 and a circular pan 1872. Pan 1872a and 1872b are parallel located at opposite ends of a housing 1870. Housing 1870 has a rectangular section 1876 removed from a side 1878. A door 1874 covers section 1876. Section 1876 is intended as access to storage of condiments and accouterments.

FIG. 29 is a perspective view of optional accessories for a food serving arrangement 1910 consisting of two parallel levels of housing unit 1982 and housing unit 1984 with enough space between the level to access condiments and accouterments located in housing 1984. Housing 1982 has rectangular section 1976 for storage of condiments and accouterments. An advantage to having housing units on different levels is to maximize the amount of food displayed minimizing space used on a surface such as a table or countertop.

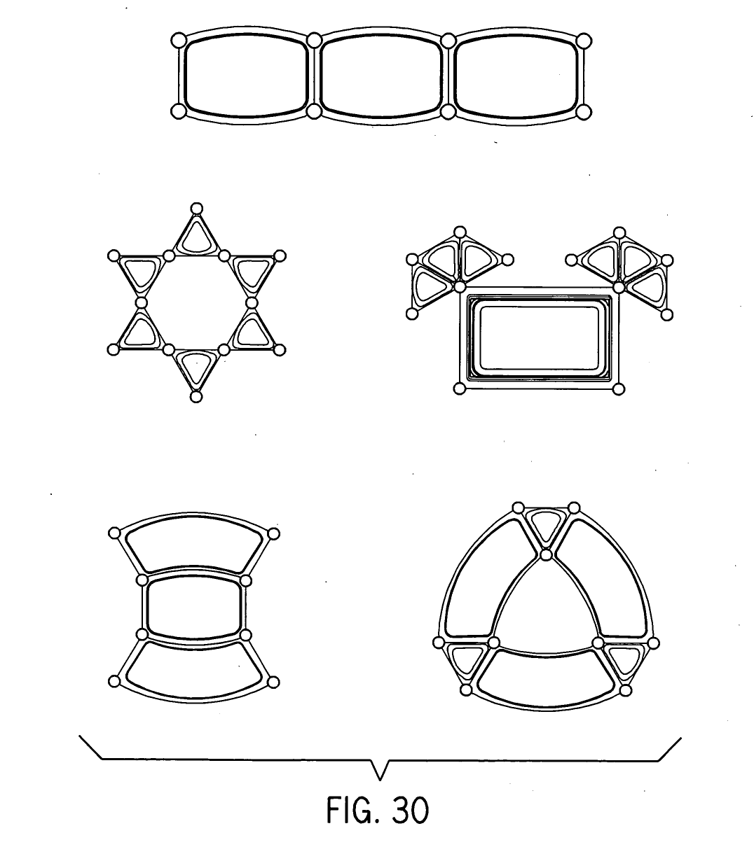

FIG. 30 shows other exemplary embodiments and configurations for food arrangement systems. According to alternative embodiments, any of a variety of arrangements may be provided using the disclosed system components.

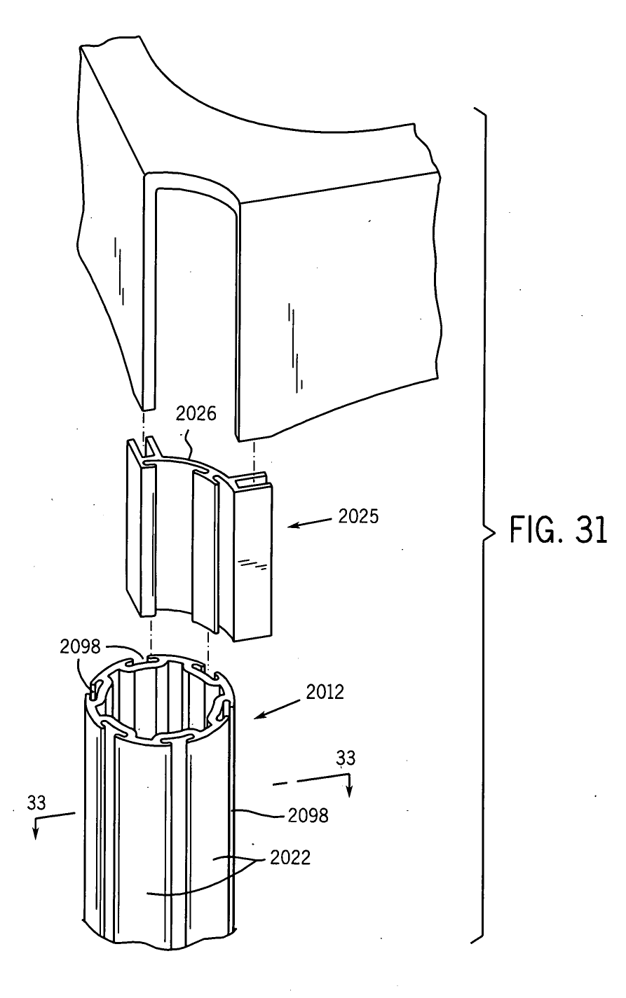

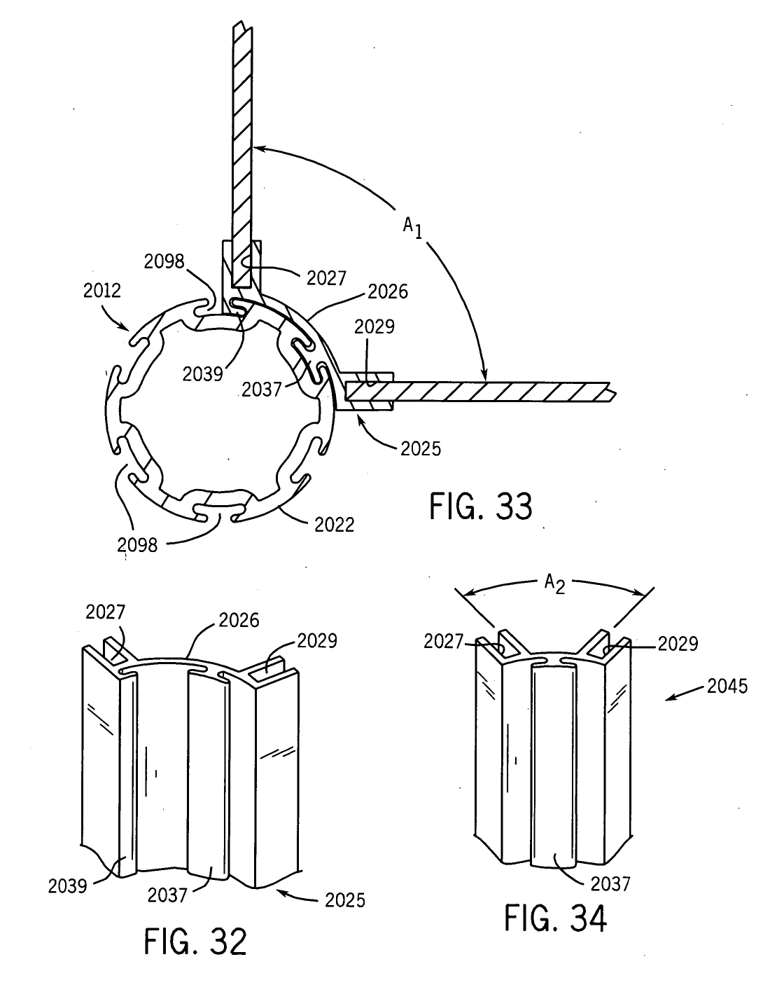

FIG. 31 is a fragmentary exploded perspective view illustrating a portion of food serving unit 2012, another embodiment of food serving unit 112 (shown in FIG. 2). Food serving unit 2012 is similar to food serving unit 112 except that food serving unit 2012 includes legs 2022 in lieu of legs 122 and additionally includes connection interfaces 2025 (one of which are shown). Like food serving units 112, food serving unit 2012 additionally includes pan 32, pan 34, cover 28, heat source support 30, feet 125 and caps 127 (shown in FIG. 2). In other embodiments, one of more of such components may be omitted.

Legs 2022 are similar to legs 122 (shown in FIG. 2) except that legs 2022 include channels or grooves 2098 in lieu of channels 198. Channels 2098 comprise elongate cavities configured to interconnect with connection interfaces 2025. In the particular embodiment illustrated, grooves 2098 comprise T-shaped grooves configured to receive portions of one or more interfaces 2025. In the particular example illustrated, each leg 2022 includes multiple grooves 2098 circumferentially spaced about an axis of leg 2022. Such grooves 2098 axially extend along a substantial entirety of leg 2022, facilitating extrusion of leg 2022. In other embodiments, grooves 2098 may alternatively be circumferentially located in a non-uniform fashion about the axis of leg 2022 or may alternatively extend along only selected axial portions of leg 2022. In still other embodiments, grooves 2098 may have other configurations depending upon the configuration of interface 2025. For example, in another embodiment, leg 2022 may alternatively include one or more tongues radially extending from leg 2022 and configured to be received within a corresponding groove of interface 2025.

Although FIG. 31 illustrates leg 2012 and interface 2025 as part of a single food serving unit 2012, such legs 2022 and interfaces 2025 may be used to interconnect illustrated food serving unit 2012 to one or more other food serving units in various arrangements such as the other food serving arrangements described in FIGS. 1-30.

Connection interface 2025 comprises one or more structures configured to facilitate interconnection of a housing, such as housing 120 shown in FIG. 2, or such as any one of the other housings described with respect to FIGS. 1-30, to associated legs 2022. Connection interface 2025 generally includes body 2026, housing connection portions 2027, 2029 and projections 2037, 2039. Body 2026 comprises a base or other structure from which connection portions 2027, 2029 and projections 2037, 2039 extend. Body 2026 interconnects such portions. In the particular example illustrated, body 2026 closely conforms to the outer circumferential surface of leg 2022 to facilitate close interconnection between housing, such as housing 120, and leg 2022. In other embodiments, body 2026 may have other configurations.

Housing connection portions 2027 and 2029 extend from body 2026 and are configured to be connected to a housing, such as housing 120. In the particular example illustrated, connection portions 2027 and 2029 comprise grooves or channels configured to slidably receive and capture adjacent edges 188 extending along groove 186 of housing 120 as shown in FIG. 33. In one particular embodiment, edges 188 extending along opening 186 of housing 120 (shown in FIG. 2) are slid into connection portions 2027 and 2029, whereby housing 120 is secured to interface 2025. In addition to facilitating interconnection of housing 120 to leg 2022, interface 2025 further rigidifies and strengthens housing 120 along edges 188 and covers such edges 188. In particular embodiments, interface 2025 may be coupled to housing 120 to protect edges 188 during storage or shipment prior to connection to a leg 2022.

In the particular example illustrated, connection portions 2027 and 2029 are angularly spaced from one another by approximately 90 degrees, facilitating connection of interface 2025 to edges 188 which are also oriented at 90 degrees relative to one another. In other embodiments, the angular spacing between connection portions 2027 and 2029 may be different to accommodate connection of interface 2025 to other housings, such as triangular housings, arcuate housings and the like, wherein such edges 188 may be at other angles with respect to one another. In yet other embodiments, connection portions 2027, 2029 may have other configurations configured so as to interconnect interface 2025 to a housing in other manners.

Projections 2037, 2039 comprise structures extending from body 2026 that are configured to connect interface 2025 to one of legs 2022. In the particular example illustrated, projection 2037 comprises a T-shaped tongue configured to be slidably received within one of grooves 2098 of leg 2022 as shown in FIG. 31. Projection 2039 comprises a L-shaped projection configured to be received within adjacent one of grooves 2098 of leg 2022. As a result, interface 2025 may be interconnected to leg 2022 as well as a housing such as housing 120 without the need for tools and without the need to manipulate one or more fasteners. In other embodiments, connection portions 2037, 2039 may have other configurations. For example, in other embodiments, interface 2025 may omit connection portion 2039 or connection portion 2037 may alternatively comprise a channel or groove configured to receive and capture a corresponding projection extending from leg 2022.

FIG. 34 illustrates connection interface 2045, another embodiment of connection interface 2025. Connection interface 2045 is similar to connection interface 2025 except that connection interface 2045 is configured to be connected to a housing having edges 188 having different angular relationships. In the particular example illustrated, interface 2045 includes connection portions 2027, 2029 which are angularly spaced from one another by 60 degrees such that connection portions 2027, 2029 receive edges 188 (shown in FIG. 2) of a housing which are angularly spaced from one another by 60 degrees rather than 90 degrees. In still other embodiments, interface 2045 may angularly space connection portions 2027, 2029 by other degrees such as 30 degrees or other angles depending upon the angular spacing between the adjacent edges of a housing.

As further shown by FIG. 34, interface 2045 omits projection 2039, wherein projection 2037 is configured to be received within one of grooves 2098 of leg 2022 (shown in FIGS. 31 and 33). Like interface 2025, interface 2045 further protects edges 188 of the associated housing to which it is connected during shipping, transport and the like, as well as strengthens and rigidifies the housing to which it is connected.

It is also important to note that the construction and arrangement of the elements of the food serving arrangement system as shown in the preferred and other exemplary embodiments are illustrative only. Although only a few embodiments of the present invention have been described in detail in this disclosure, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited in the claims. For example, although different example embodiments may have been described as including one or more features providing one or more benefits, it is contemplated that the described features may be interchanged with one another or alternatively be combined with one another in the described example embodiments or in other alternative embodiments. Further, any of a variety of arrangements, configurations, reconfigurations may be provided using the disclosed system. Accordingly, all such modifications are intended to be included within the scope of the present invention as defined in the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Further, unless specifically otherwise noted, the claims or examples reciting a single particular element also encompass a plurality of such particular elements. Other substitutions, modifications, changes and/or omissions may be made in the design, operating conditions and arrangement of the preferred and other exemplary embodiments without departing from the spirit of the present invention as expressed in the appended claims.

What is claimed is:

1. A food serving arrangement comprising:
a first pan;
a second pan; and
a plurality of legs supporting the first pan and the second pan, wherein the first pan and the second pan share a first leg of the plurality of legs between the first pan and the second pan.

2. The arrangement of claim 1 further comprising:
a first housing supporting the first pan; and
a second housing supporting the second pan, wherein the first housing and the second housing are interconnected by the first leg.

3. The arrangement of claim 2, wherein the first housing is removably attached to the first leg.

4. The arrangement of claim 3, wherein the second housing is removably attached to the first leg.

5. The arrangement of claim 2, wherein the first pan and the second pan have different shapes.

6. The arrangement of claim 2, wherein the first housing is triangular.

7. The arrangement of claim 2, wherein the first housing is oblong.

8. The arrangement of claim 2, wherein the first housing is curved.

9. The arrangement of claim 2, wherein the first housing has a concave wall and wherein the second housing has a convex wall adjacent the concave wall.

10. The arrangement of claim 2, wherein the first housing and the second housing have different shapes.

11. The arrangement of claim 1 further comprising a third pan, wherein the plurality of legs supports the third pan and wherein the third pan and the second pan share a second leg of the plurality of legs.

12. The arrangement of claim 11 further comprising a third housing supporting the third pan, wherein the second housing and the third housing are interconnected by the first leg.

13. The arrangement of claim 12, wherein the third housing is removably attached to the first leg.

14. The arrangement of claim 1, wherein the first pan and the second pan are supported at different heights.

15. The arrangement of claim 1, wherein the first pan and the second pan are triangular.

16. The arrangement of claim 1 further comprising:
a third pan; and
a fourth pan, wherein the plurality of legs supports the third pan and the fourth pan, wherein the third pan and the second pan share a second leg of the plurality of legs and wherein the fourth pan and the third pan share a third leg of the plurality of legs.

17. The arrangement of claim 16 further comprising:
a third housing supporting the third pan; and
a fourth housing supporting the fourth pan, wherein the third housing and the fourth housing are interconnected by the second leg.

18. The arrangement of claim 17, wherein the third housing is removably attached to the second leg.

19. The arrangement of claim 1 further comprising a panel extending between two of the plurality of legs above the first pan.

20. The arrangement of claim 1 further comprising a transparent panel extending over the first pan.

21. The arrangement of claim 1, wherein the first leg has a length of less than or equal to about 2 feet.

22. The arrangement of claim 1, wherein the first leg has a length of less than or equal to about 12 inches.

23. The arrangement of claim 1 further comprising:
a first housing supporting the first pan; and
a second housing supporting the second pan, wherein the first housing has a height of less than or equal to about 12 inches.

24. The arrangement of claim 1, wherein the first leg extends along an axis and includes a plurality of connection portions circumferentially located about the axis.

25. The arrangement of claim 24, wherein the plurality of connection portions include a plurality of axially extending grooves.

26. The arrangement of claim 25, wherein the grooves extend substantially along an entire length of the first leg.

27. The arrangement of claim 25 further comprising a first housing supporting the first pan, wherein the first housing is received within two of the grooves.

28. The arrangement of claim 27, wherein the two grooves are angularly spaced about 90 degrees from one another about the axis.

29. The arrangement of claim 1, wherein the first leg is extruded.

30. The arrangement of claim 1 further comprising a third pan received within the first pan and having a bottom spaced from a floor of the first pan.

31. The arrangement of claim 1, wherein the first pan is triangular having a first corner proximate to the first leg, wherein the second pan is triangular having a second corner proximate to the first leg and wherein the first pan and the second pan are angularly offset about the first leg.

32. The arrangement of claim 31, wherein the first pan and the second pan are at different heights along the first leg.

33. The arrangement of claim 1, wherein the plurality of legs includes a second leg shared by the first pan and the second pan and between the first pan and the second pan.

34. A food serving arrangement comprising:
a plurality of food serving units, each unit having a bottom and a pan spaced from the bottom by less than or equal to about 2 feet, wherein the plurality of units are releasably connected to one another.

35. The arrangement of claim 34, wherein the plurality of food service units includes a first unit and a second unit and wherein the first unit and the second unit are releasably connected to one another by a first leg between the first unit and the second unit.

36. The arrangement of claim 34, wherein each unit includes a housing, wherein the pan is removably received within the housing.

37. The arrangement of claim 34, wherein the top of the pan is spaced from the bottom by less than or equal to about 12 inches.

38. The arrangement of claim 34, wherein the plurality of units includes a first unit having a first pan and a second unit having a second pan, wherein the top of the first pan is vertically spaced from the top of the second pan.

39. A food serving arrangement comprising:
a first food serving unit having a first pan with a first top at a first height; and
a second food serving unit connected to the first unit having a second pan with a second top at a second height.

40. The arrangement of claim 39, wherein the first unit and the second unit share a first leg.

41. The arrangement of claim 39, wherein the first unit and the second unit are releasably connected to one another.

42. A food serving arrangement comprising:
a plurality of food serving unit, each unit including a pan, wherein the plurality of food serving units are connected to one another and have a continuous convex outer perimeter.

43. A food serving unit comprising:
a first pan;
a first housing supporting the first pan; and
legs coupled to the housing, wherein the legs include a first leg configured to be releasably connected to a second unit without fasteners.

44. The arrangement of claim 43, wherein the first leg receives a first portion of the first housing and is configured to receive a second portion of a second housing of the second unit.

45. The food serving unit of claim 43, wherein the first leg receives two spaced portions of the first housing.

46. The food serving unit of claim 43, wherein the first housing is formed from a bent sheet of material.

47. The food serving unit of claim 46, wherein the material is a metal.

48. The food serving unit of claim 43, wherein the first leg includes axially extending grooves.

49. The food serving unit of claim 43, wherein the first leg is extruded.

50. A pan support comprising:
a first housing configured to support a pan; and
legs coupled to the housing, wherein the legs include a first leg configured to be releasably connected to a second housing without fasteners.

51. A method for providing a food serving arrangement, the method comprising:
providing a food serving unit having at least one pan supported by a leg; and
releasably connecting a second food serving unit having a second pan to the leg of the first unit.

52. The method of claim 51, wherein the first pan and the second pan are angularly offset from one another about an axis.

53. The method of claim 51, wherein the first pan and the second pan are at different heights.

54. The method of claim 51 further comprising:
positioning the first unit and the second unit upon a surface raised above the floor of a room.

55. The method of claim 51, wherein the first unit has a bottom and wherein the first pan has a top spaced from the bottom by less than or equal to about 2 feet.

56. The method of claim 51, wherein the first unit has a bottom and wherein the first pan has a top spaced from the bottom by less than or equal to about 12 inches.

57. An apparatus comprising:
a housing comprising:
a frame having an opening configured to receive a pan; and
a plurality of panels extending non-parallel from the frame, wherein consecutive panels have spaced edges along comers of the housing.

58. The apparatus of claim 57 further comprising:
a connection interface connected to the housing along a corner of the housing, wherein the connection interface is configured to be connected to a leg.

59. The apparatus of claim 57, further comprising one or more accessories coupled to the housing.

60. The apparatus of claim 59, wherein the one or more accessories are removably coupled to the housing.

61. The apparatus of claim 59, wherein the one or more accessories comprises one or more utensil rest, signage, lighting, splash guard, overhang, backing, or combinations thereof.
